(19) United States
(12) Patent Application Publication
(10) Pub. No.: US 2025/0374353 A1
(43) Pub. Date: Dec. 4, 2025

(54) DATA CONNECTION WITH EXTERNAL ACCESS PATH

(71) Applicant: Lenovo (Singapore) Pte. Ltd., New Tech Park (SG)

(72) Inventor: Apostolis Salkintzis, Athens (GR)

(21) Appl. No.: 18/707,789

(22) PCT Filed: Dec. 9, 2021
(86) PCT No.: PCT/EP2021/085105

§ 371 Date: May 6, 2024

(30) Foreign Application Priority Data
Nov. 5, 2021 (GR) 20210100774

(51) Int. Cl. H04W 76/15; H04W 12/06; H04W 40/24; H04W 80/06

(52) U.S. Cl. CPC H04W 76/15; H04W 12/06; H04W 40/246; H04W 80/06

(57) ABSTRACT

OF THE DISCLOSURE Apparatuses, methods, and systems are disclosed for establishing a multi-access data connection with an external access path. One apparatus (500) includes a transceiver (525) that communicates (705) with first and second mobile networks and a processor (505) that sends (710) a request message to the first mobile network to establish a multi-access data connection, the request message containing an external access path request. The processor (505) receives (715) a response message that accepts the request to establish a multi-access data connection and that contains a set of rules indicating how the apparatus (500) is to route data traffic across a set of access networks in the first mobile network and across an external access path over the second mobile network. The processor (505) communicates (720) with a UPF in the first network over the set of access networks and the external access path.

### FIELD

The subject matter disclosed herein relates generally to wireless communications and more particularly relates to procedures to enable a multi-access data connection supporting data communication via different Public Land Mobile Networks (“PLMNs”).

### BACKGROUND

When two PLMNs have roaming agreements, a User Equipment (“UE”) device may use a single set of credentials to establish connections traversing different PLMNs.

### BRIEF SUMMARY

Disclosed are procedures for establishing a multi-access data connection with an external access path. Said procedures may be implemented by apparatus, systems, methods, or computer program products.

One method of a User Equipment (“UE”) device for establishing a multi-access data connection with an external access path includes communicating with a first mobile communication network and a second mobile communication network via a plurality of access networks and sending a request message to the first mobile communication network to establish a multi-access data connection, where the request message contains an external access path request that indicates that the multi-access data connection is to support communication via the second mobile communication network. The method includes receiving a response message from the first mobile communication network that accepts the request to establish a multi-access data connection and communicating with a user plane function (“UPF”) in the first mobile communication network via the set of access networks and the external access path, where the response message contains a set of rules indicating how the apparatus is to route data traffic across a set of access networks in the first mobile communication network and across an external access path over the second mobile communication network.

One method of a policy control function (“PCF”) in a first mobile communication network for establishing a multi-access data connection with an external access path includes receiving a policy request for a multi-access data connection of a UE, the policy request containing an external access path request that indicates that the multi-access data connection is to support communication via a second mobile communication network. The method includes generating a set of rules indicating how data traffic of the multi-access data connection it to be routed across a set of access networks in the first mobile communication network and across an external access path over the second mobile communication network. The method includes sending a response message to a session management function, the response message including the set of rules.

One method of a UPF in a first mobile communication network for establishing a multi-access data connection with an external access path includes receiving a session establishment request for a multi-access data connection of a UE, the session establishment request containing a set of rules for routing downlink traffic of the multi-access data connection across a set of access networks in the first mobile communication network and across an external access path over a second mobile communication network. The method includes assigning a first network address to the multi-access data connection for enabling UE communication via the set of access networks in the first mobile communication network and assigning a second network address to the multi-access data connection for communicating with the UE via the external access path over the second mobile communication network. The method includes communicating with the UE via the set of access networks and the external access path.

One method of a session management function (“SMF”) in a first mobile communication network for establishing a multi-access data connection with an external access path includes receiving a session request for a multi-access data connection of a UE, the request containing an external access path request that indicates that the multi-access data connection is to support communication via a second mobile communication network. The method includes sending a policy request to a PCF, the policy request containing the external access path request and receiving a policy response from the PCF, the policy response including a first set of rules. The method includes sending a session establishment request to a UPF, the session establishment request message containing a second set of rules for routing downlink traffic across a set of access networks in the first mobile communication network and across an external access path over the second mobile communication network. The method includes sending a session response, the session response containing a third set of rules for routing uplink traffic across the set of access networks in the first mobile communication network and across the external access path over the second mobile communication network.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a block diagram illustrating one embodiment of a wireless communication system for establishing a multi-access data connection with an external access path;

FIG. 2 is a diagram illustrating one embodiment of a multi-access data connection comprising an external access path via a different PLMN;

FIG. 3A is a call-flow diagram illustrating one embodiment of a procedure for establishing a Multi Access Protocol Data Unit (“MA PDU”) Session that supports an external access path;

FIG. 3B is a continuation of the call-flow diagram of FIG. 3A;

FIG. 3C is a continuation of the call-flow diagrams of FIGS. 3A and 3B;

FIG. 4A is a call-flow diagram illustrating one embodiment of a procedure for modifying a MA PDU Session to support an external access path;

FIG. 4B is a continuation of the call-flow diagram of FIG. 4A;

FIG. 4C is a continuation of the call-flow diagrams of FIGS. 4A and 4B;

FIG. 5 is a block diagram illustrating one embodiment of a user equipment apparatus that may be used for establishing a multi-access data connection with an external access path;

FIG. 6 is a block diagram illustrating one embodiment of a network apparatus that may be used for establishing a multi-access data connection with an external access path;

FIG. 7 is a flowchart diagram illustrating one embodiment of a first method for establishing a multi-access data connection with an external access path;

FIG. 8 is a flowchart diagram illustrating one embodiment of a second method for establishing a multi-access data connection with an external access path;

FIG. 9 is a flowchart diagram illustrating one embodiment of a third method for establishing a multi-access data connection with an external access path; and

FIG. 10 is a flowchart diagram illustrating one embodiment of a fourth method for establishing a multi-access data connection with an external access path.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The call-flow diagrams, flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the call-flow, flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatus for establishing a multi-access data connection having an external access path via a different PLMN. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

As already specified in Third-Generation Partnership Project (“3GPP”) specifications, a UE capable of supporting Access Traffic Steering, Switching, and/or Splitting (“ATSSS”), can simultaneously communicate with a 5G Core network (“5GC”) over a 3GPP access network (e.g., NG-RAN) and over a non-3GPP access network (e.g., WLAN). In such embodiments, the traffic exchanged between the UE and a Remote Host can either be distributed over both accesses (e.g., for bandwidth aggregation) or can be sent on the “best” access only, e.g., on the access characterized by the smallest latency, or the smallest Round-Trip Time (“RTT”). In the uplink (“UL”) direction, the UE decides how to distribute the traffic across the two accesses based on policy rules (called ATSSS rules) provided by the network. Similarly, in the downlink (“DL”) direction, the UPF at the edge of 5GC decides how to distribute the traffic across the two accesses based on corresponding policy rules (called N4 rules). Note that current 3GPP specifications only support ATSSS for two access paths.

Future networks may support ATSSS for more than two access paths and, importantly, where an access path traverses a different PLMN. In an example scenario related with this requirement, the UE may have two different Universal Subscriber Identity Module (“USIM”) modules, one for a first PLMN and another for the second PLMN. In one embodiment, the first PLMN supports a 3GPP satellite access network (aka Non-Terrestrial Network or “NTN”) and the second PLMN supports a 3GPP terrestrial access network (e.g., NG-RAN) and a non-3GPP access network (e.g., Wi-Fi or WLAN). The operator of the second PLMN may allow the UE to establish a Multi Access (“MA”) Protocol Data Unit (“PDU”) Session, which may support an access path external to the second PLMN, e.g., may use a satellite access network in the first PLMN.

In an alternative scenario, the access path that is external to the second PLMN does not use a satellite access network in a certain PLMN, but may use any other Internet Protocol (“IP”) access network provided, e.g., by an Internet Service Provider (“ISP”). In this case, the external access path may traverse a cable/fiber access network, or a Wi-Fi access network.

The present disclosure describes solutions to enhance the ATSSS feature in order to support an external access path for a multi-access data connection. Note that in some embodiments, the multi-access data connection may be described as a “multi access” data connection, e.g., in standard specifications. Further, the multi-access data connection may comprise a Multi Access Protocol Data Unit (“MA PDU”) Session, a multi-path (“MP”) Packet Data Network (“PDN”) connection, a Multi-Path Transmission Control Protocol (“MPTCP”) connection, a multi-path QUIC connection, or other multi-path connection using multiple access networks. Further, the solutions described below enhance the ATSSS feature in order to support for additional access paths, such as two access paths via one PLMN and a third access path via the other PLMN.

According to a first solution, a UE may establish a new MA PDU Session (or other multi-access data connection) to support data traffic via an access path in a different PLMN. According to a second solution, a UE may modify an existing MA PDU Session (or other multi-access data connection) to support data traffic via an access path in a different PLMN.

In the below described solutions, it is assumed that the two PLMNs do not have roaming agreements. Therefore, the UE registers with each PLMN using a different set of 3GPP credentials and/or a different USIM. In one example, the UE is multiple-USIM (“MUSIM”) capable, i.e., it supports enhanced functionality for operating simultaneously with multiple different PLMNs.

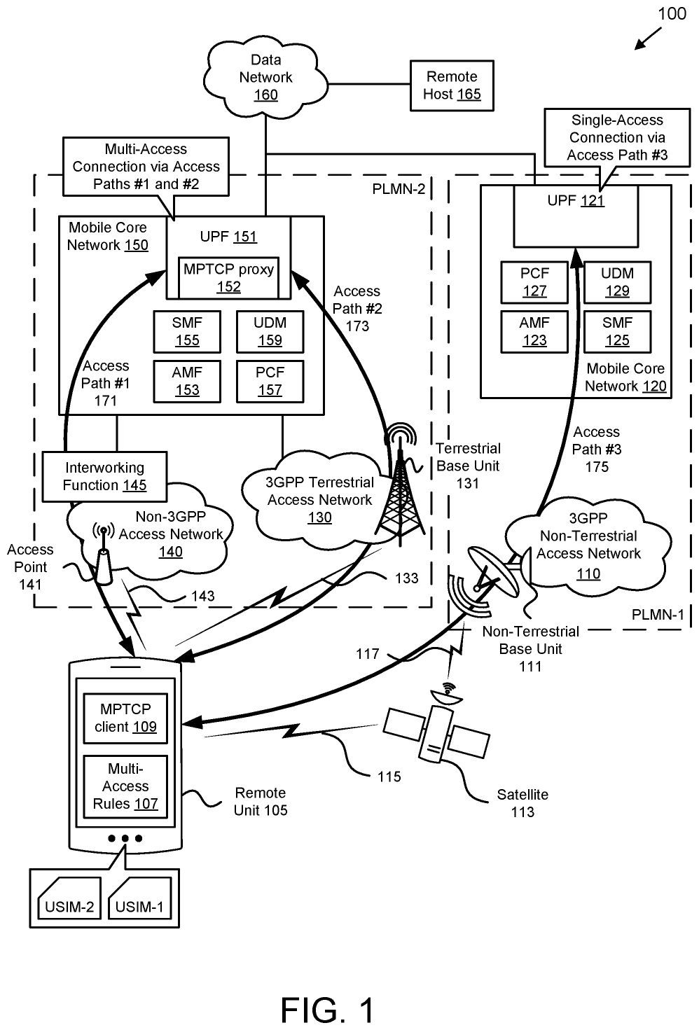

FIG. 1 depicts a wireless communication system 100 for establishing a multi-access data connection with an external access path, according to embodiments of the disclosure. In one embodiment, the wireless communication system 100 includes at least one remote unit 105, a 3GPP non-terrestrial access network 110, a first mobile core network 120, a 3GPP terrestrial access network 130, a non-3GPP access network 140, and a second mobile core network 150. The 3GPP non-terrestrial access network 110 (i.e., containing at least one non-terrestrial base unit 111 and satellite 113) and the first mobile core network 120 form a first mobile communication network, denoted as “PLMN-1”. The 3GPP terrestrial access network 130 (i.e., containing at least one terrestrial base unit 131), the non-3GPP access network 140 (i.e., containing at least one access point 141), and the second mobile core network 150 form a second mobile communication network, denoted as “PLMN-2”.

Even though a specific number of remote units 105, 3GPP non-terrestrial access networks 110, first mobile core networks 120, 3GPP terrestrial access networks 130, non-3GPP access networks 140, and second mobile core networks 150 are depicted in FIG. 1, one of skill in the art will recognize that any number of remote units 105, 3GPP non-terrestrial access networks 110, first mobile core networks 120, 3GPP terrestrial access networks 130, non-3GPP access networks 140, and second mobile core networks 150 may be included in the wireless communication system 100.

In the 3GPP non-terrestrial access network 110, the remote unit 105 communicates with one or more satellites 113 via service link(s) 115, while the satellite(s) 113 communicate with the non-terrestrial base unit 111 via feeder link(s) 117. In the 3GPP terrestrial access network 130, the remote unit 105 communicates with one or more terrestrial base units 131 using wireless communication links 133. In the non-3GPP access network 140, the remote unit 105 communicates with one or more access points 141 using wireless communication links 143.

In one implementation, the 3GPP non-terrestrial access network(s) 110 and 3GPP terrestrial access network(s) 130 are compliant with the Fifth-Generation (“5G”) system specified in the Third Generation Partnership Project (“3GPP”) specifications. In another implementation, the 3GPP terrestrial access network 130 is compliant with the LTE system specified in the 3GPP specifications. For example, the 3GPP terrestrial access network 130 may comprise a New Generation Radio Access Network (“NG-RAN”), implementing New Radio (“NR”) Radio Access Technology (“RAT”) and/or Long-Term Evolution (“LTE”) RAT. Moreover, the non-3GPP access network 140 may comprise a non-3GPP RAT (e.g., Wi-Fi® or Institute of Electrical and Electronics Engineers (“IEEE”) 802.11-family compliant WLAN).

More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the non-terrestrial base units 111 in the 3GPP non-terrestrial access network 110 via uplink (“UL”) and downlink (“DL”) communication signals carried over the service link(s) 115 and feeder link(s) 117. The remote units 105 may communicate directly with one or more of the terrestrial base units 131 in the 3GPP terrestrial access network 130 via UL and DL communication signals carried over the wireless communication links 133. Similarly, the remote units 105 may communicate with one or more access points 141 in the non-3GPP access network(s) 140 via UL and DL communication signals carried over the wireless communication links 143. Here, the access networks 110, 130 and 140 are intermediate networks that provide the remote units 105 with access to the first mobile core network 120 and/or second mobile core network 150.

In some embodiments, the remote units 105 communicate with a remote host 165 (e.g., an application server) in the packet data network 160 via a network connection with the first mobile core network 120 and/or second mobile core network 150. For example, an application (e.g., web browser, media client, telephone and/or Voice-over-Internet-Protocol (“VoIP”) application) in a remote unit 105 may trigger the remote unit 105 to establish a protocol data unit (“PDU”) session (or other data connection) with a mobile core network (i.e., first mobile core network 120 and/or second mobile core network 150) via an access network (i.e., 3GPP non-terrestrial access network 110, 3GPP terrestrial access network 130 and/or non-3GPP access network 140). The mobile core network then relays traffic between the remote unit 105 and the remote host 165 using the PDU session. The PDU session represents a logical connection between the remote unit 105 and the User Plane Function (“UPF”).

In order to establish the PDU session (or PDN connection), the remote unit 105 must be registered with the mobile core network (also referred to as “attached to the mobile core network” in the context of a Fourth Generation (“4G”) system). Note that the remote unit 105 may establish one or more PDU sessions (or other data connections) with the mobile core network. As such, the remote unit 105 may have at least one PDU session for communicating with the packet data network 160. The remote unit 105 may establish additional PDU sessions for communicating with other data networks and/or other communication peers.

As used herein, Protocol Data Units (“PDUs”) refer to packets exchanged between peer entities in the same layer (e.g., of a protocol stack). In the context of a 5G system (“5GS”), the term “PDU Session” refers to a data connection that provides end-to-end (“E2E”) user plane (“UP”) connectivity between the remote unit 105 and a specific Data Network (“DN”) through the UPF. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QoS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network (i.e., the first mobile core network 120 and/or second mobile core network 150). In certain embodiments, there is a one-to-one mapping between an EPS Bearer and a QoS profile, such that all packets belonging to a specific EPS Bearer have the same QoS Class Identifier (“QCI”).

The satellite(s) 113 may provide service over a geographic region. The satellite(s) 113 may serve a number of remote units 105 within a serving area, for example, a cell or a cell sector, via a service link 115. Generally, the satellite(s) 113 transmit DL communication signals to serve the remote units 105 in the time, frequency, and/or spatial domain. In one embodiment, the 3GPP non-terrestrial access network 110 is a transparent-payload NTN system where the satellite(s) 113 repeat the waveform signal for the non-terrestrial base unit 111. In other embodiments, the 3GPP non-terrestrial access network 110 is a regenerative-payload NTN system where the satellite(s) 113 demodulate received uplink Radio Frequency (“RF”) signal to recover the baseband signal and later re-modulate the baseband signal.

As depicted, the first mobile communication network includes an “on-ground” non-terrestrial base unit 111 which serves the remote unit 105 via satellite access. In other embodiments, certain RAN entities or functions may be incorporated into the satellite 113. For example, the satellite 113 may be an embodiment of a Non-Terrestrial base station/base unit. The non-terrestrial base units 111 are generally part of an access network (“AN”), such as the 3GPP non-terrestrial access network 110, that may include one or more controllers communicably coupled to one or more corresponding non-terrestrial base units 111. In some embodiments, the non-terrestrial base unit 111 comprises a non-terrestrial network (“NTN”) gateway (e.g., satellite ground/earth devices). These and other elements of radio access network are not illustrated but are well known generally by those having ordinary skill in the art. The non-terrestrial base units 111 connect to the mobile core network 120 via the 3GPP non-terrestrial access network 110.

The terrestrial base units 131 may be distributed over a geographic region. In certain embodiments, a terrestrial base unit 131 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The terrestrial base units 131 are generally part of an access network (“AN”), such as the 3GPP terrestrial access network 130, that may include one or more controllers communicably coupled to one or more corresponding terrestrial base units 131. These and other elements of radio access network are not illustrated but are well known generally by those having ordinary skill in the art. The terrestrial base units 131 connect to the mobile core network 150 via the 3GPP terrestrial access network 130.

The terrestrial base units 131 may serve a number of remote units 105 within a serving area, for example, a cell or a cell sector, via a wireless communication link 133. The terrestrial base units 131 may communicate directly with one or more of the remote units 105 via communication signals. Generally, the terrestrial base units 131 transmit DL communication signals to serve the remote units 105 in the time, frequency, and/or spatial domain. Furthermore, the DL communication signals may be carried over the wireless communication links 133. The wireless communication links 133 may be any suitable carrier in licensed or unlicensed radio spectrum. The wireless communication links 133 facilitate communication between one or more of the remote units 105 and/or one or more of the terrestrial base units 131. Note that during NR operation on unlicensed spectrum (referred to as “NR-U”), the terrestrial base unit 131 and the remote unit 105 communicate over unlicensed (i.e., shared) radio spectrum.

The non-3GPP access networks 140 may be distributed over a geographic region. Each non-3GPP access network 140 may serve a number of remote units 105 with a serving area. An access point 141 in a non-3GPP access network 140 may communicate directly with one or more remote units 105 by receiving UL communication signals and transmitting DL communication signals to serve the remote units 105 in the time, frequency, and/or spatial domain. Both DL and UL communication signals are carried over the wireless communication links 143. In some embodiments, the wireless communication links 133 and the wireless communication links 143 may employ different frequencies and/or different communication protocols. In various embodiments, an access point 141 may communicate using unlicensed radio spectrum.

In one embodiment, the mobile core network 120 is a 5GC or an Evolved Packet Core (“EPC”), which may be coupled to a packet data network 160, like the Internet and private data networks, among other data networks. A remote unit 105 may have a subscription or other account with the mobile core network 120. In various embodiments, each mobile core network 140 belongs to a single mobile network operator (“MNO”). The present disclosure is not intended to be limited to the implementation of any particular wireless communication system architecture or protocol.

The mobile core network 120 includes several network functions (“NFs”). As depicted, the mobile core network 120 includes at least one UPF 121. The mobile core network 120 also includes multiple control plane (“CP”) functions including, but not limited to, an Access and Mobility Management Function (“AMF”) 123 that serves the 3GPP non-terrestrial access network 110, a Session Management Function (“SMF”) 125, a Policy Control Function (“PCF”) 127, and a Unified Data Management function (“UDM”) 129. In some embodiments, the UDM 129 is co-located with a User Data Repository (“UDR”), and thus may be referred to as combined entity “UDM/UDR”.

Similarly, the mobile core network 150 may be a 5GC or an Evolved Packet Core (“EPC”) that is coupled to a packet data network 160, like the Internet and private data networks, among other data networks. A remote unit 105 may have a subscription or other account with the mobile core network 150. In various embodiments, each mobile core network 150 belongs to a single MNO. The present disclosure is not intended to be limited to the implementation of any particular wireless communication system architecture or protocol.

The mobile core network 150 includes several network functions (“NFs”). As depicted, the mobile core network 150 includes at least one UPF 151, an AMF 153 that serves the 3GPP terrestrial access network 130 and/or non-3GPP access network 140, a SMF 155, a PCF 157, and a UDM 159UDR. In some embodiments, the UDM 159 is co-located with a UDR, and thus may be referred to as combined entity “UUDRUDR”. Although specific numbers and types of network functions are depicted in FIG. 1, one of skill in the art will recognize that any number and type of network functions may be included in the mobile core networks 120 and 150.

The UPFs 121 and 151 are responsible for packet routing and forwarding, packet inspection, QoS handling, and external PDU session for interconnecting Data Network (“DN”), in the 5G architecture. The AMFs 123 and 153 are responsible for termination of Non-Access Stratum (“NAS”) signaling, NAS ciphering & integrity protection, registration management, connection management, mobility management, access authentication and authorization, security context management. In the depicted embodiment, the UPF 151 comprises an Multi Path Transmission Control Protocol (“MPTCP”) proxy 152 which establishes a MPTCP connection with the MPTCP client 109 of the remote unit 105. As used herein, a MPTCP connection allows a Transmission Control Protocol (“TCP”) connection to simultaneously use multiple paths, e.g., to maximize resource usage and/or to increase redundancy.

The SMFs 125 and 155 are responsible for session management (i.e., session establishment, modification, release), remote unit (i.e., UE) IP address allocation & management, DL data notification, and traffic steering configuration of the UPFs 121 or 151 for proper traffic routing. The PCF 127 and 157 are responsible for unified policy framework, providing policy rules to CP functions, access subscription information for policy decisions in UDR.

The UDMs 129 and 159 are responsible for generation of Authentication and Key Agreement (“AKA”) credentials, user identification handling, access authorization, subscription management. The UDRs are repositories of subscriber information and may be used to service a number of network functions. For example, the UDR may store subscription data, policy-related data, subscriber-related data that is permitted to be exposed to third party applications, and the like.

In various embodiments, the mobile core networks 120 and/or 150 may also include a Network Repository Function (“NRF”) (which provides Network Function (“NF”) service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), or other NFs defined for the 5GC.

In various embodiments, the mobile core network networks 120 and 150 support different types of mobile data connections and different types of network slices, wherein each mobile data connection utilizes a specific network slice. Here, a “network slice” refers to a portion of the mobile core network optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine-type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a single-network slice selection assistance information (“S-NSSAI”) while a set of network slices for which the remote unit 105 is authorized to use is identified by network slice selection assistance information (“NSSAI”). Here, “NSSAI” refers to a vector value including one or more S-NSSAI values. In certain embodiments, the various network slices may include separate instances of network functions, such as the SMF and UPF. In some embodiments, the different network slices may share some common network functions, such as the AMF. The different network slices are not shown in FIG. 1 for ease of illustration, but their support is assumed.

While FIG. 1 depicts components of a 5G RAN and a 5G core network, the described embodiments for establishing a multi-access data connection with an external access path apply to other types of communication networks and RATs, including IEEE 802.11 variants, Global System for Mobile Communications (“GSM”, i.e., a 2G digital cellular network), General Packet Radio Service (“GPRS”), Universal Mobile Telecommunications System (“UMTS”), LTE variants, CDMA 2000, Bluetooth, ZigBee, Sigfox, and the like.

Moreover, in an LTE variant where the mobile core network 120 and/or 150 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF may be mapped to an MME, the SMF may be mapped to a control plane portion of a PGW and/or to an MME, the UPF may be mapped to an SGW and a user plane portion of the PGW, the UDM/UDR may be mapped to an HSS, etc.

In the following descriptions, the term “UE” is used for the mobile station/remote unit, but it is replaceable by any other remote device, e.g., remote unit, MS, ME, etc. Further, the operations are described mainly in the context of 5G NR. However, the below described solutions/methods are also equally applicable to other mobile communication systems for establishing a multi-access data connection with an external access path.

In various embodiments, the remote unit 105 (i.e., UE) communicates with a Remote Host 165 via: 1) a multi-access PDU Session in PLMN-2 supporting data transmission over a first access path (denoted as “Access Path #1”) 171 using non-3GPP access network 140 and over an second access path (denoted as “Access Path #2”) 173 using 3GPP terrestrial access network 130; and 2) a single-access PDU Session in PLMN-1 supporting data transmission over a third access path (denoted as “Access Path #3”) 175 using 3GPP non-terrestrial access network 110. The remote unit 105 directs uplink traffic over one or more access path according to a set of multi-access rules 107.

The first and second access paths 171, 173 have a common anchor in the UPF 151 in the PLMN-2. The third access path 175 anchors at the UPF 121 but, as described later, the data traffic on this access path is also forwarded to the UPF 151. It is assumed that the remote unit 105 (i.e., UE) has two different USIMs, one for PLMN-1 and another for PLMN-2.

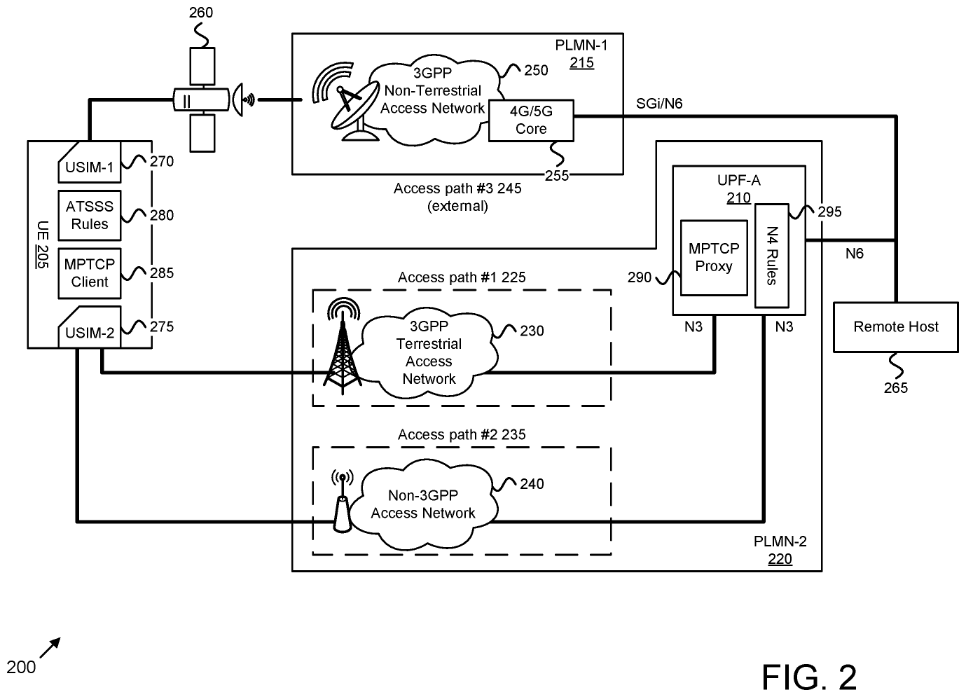

FIG. 2 depicts a network architecture 200 supporting a multi-access data connection having an external access path over a different PLMN, according to embodiments of the disclosure. The network architecture 200 includes a UE 205 (e.g., one embodiment of the remote unit 105) and an anchor UPF (denoted as “UPF-A”) 210 that anchors a multi-access data connection, such as a MA PDU Session, having an external access path over a first PLMN (denoted as “PLMN-1”) 215, where the UPF-A 210 is located in a second PLMN (denoted as “PLMN-2”) 220.

As depicted, the multi-access data connection comprises a first access path (denoted as Access Path #1) 225 over a 3GPP terrestrial access network 230 in PLMN-2 220, a second access path (denoted as Access Path #2) 235 over a non-3GPP access network 240 in PLMN-2 220, and a third access path (denoted as Access Path #3) 245 over a 3GPP non-terrestrial access network 250 and 4G/5G core network 255 in PLMN-1 215. In some embodiments, the Access Path #1 225 and Access Path #2 235 form a multi-path connection (e.g., MA PDU Session) in the PLMN-2. The UE 205 communicates with the remote host 265 via one or more of the Access Path #1 225, Access Path #2 235, and Access Path #3 245, i.e., according to configured ATSSS rules 280.

The UE 205 comprises a first USIM (denoted as “USIM-1”) 270 for the PLMN-1 215 and a second USIM (denoted as “USIM-2”) 275 for the PLMN-2 220. As discussed above, the UE 205 is configured with ATSSS rules 280 for routing UL traffic over one or more of the Access Path #1 225, Access Path #2 235, and Access Path #3 245. Similarly, the UPF-A 210 may be configured with N4 rules 295 for routing DL traffic over one or more of the Access Path #1 225, Access Path #2 235, and Access Path #3 245.

In various embodiments, the UE 205 and UPF-A 210 establish a MPTCP connection over the Access Path #1 225, Access Path #2 235, and Access Path #3 245. In such embodiments, the UE 205 also comprises a MPTCP client 285 which communicates with a MPTCP proxy 290 in the UPF-A 210. In the UL direction, the MPTCP proxy 290 combines the TCP traffic receives over the Access Path #1 225, Access Path #2 235, and/or Access Path #3 245 and forwards this combined UL traffic to the Remote Host 265. In the DL direction, the MPTCP proxy 290 splits the TCP traffic receives from the remote host and forwards this split DL traffic to the UE 205 across the Access Path #1 225, Access Path #2 235, and/or Access Path #3 245.

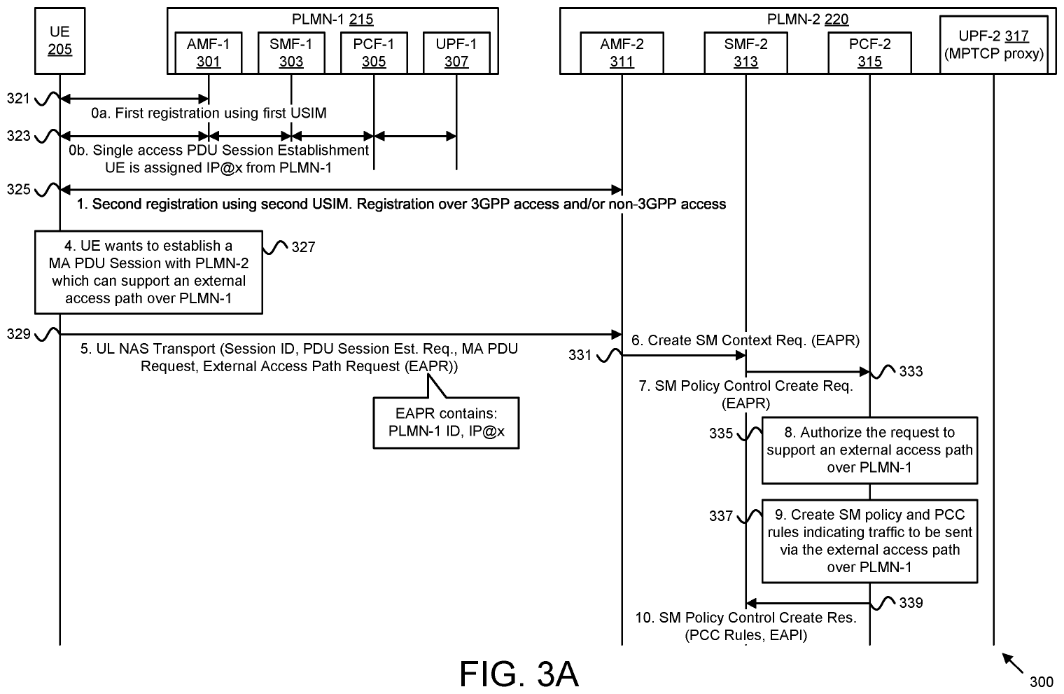

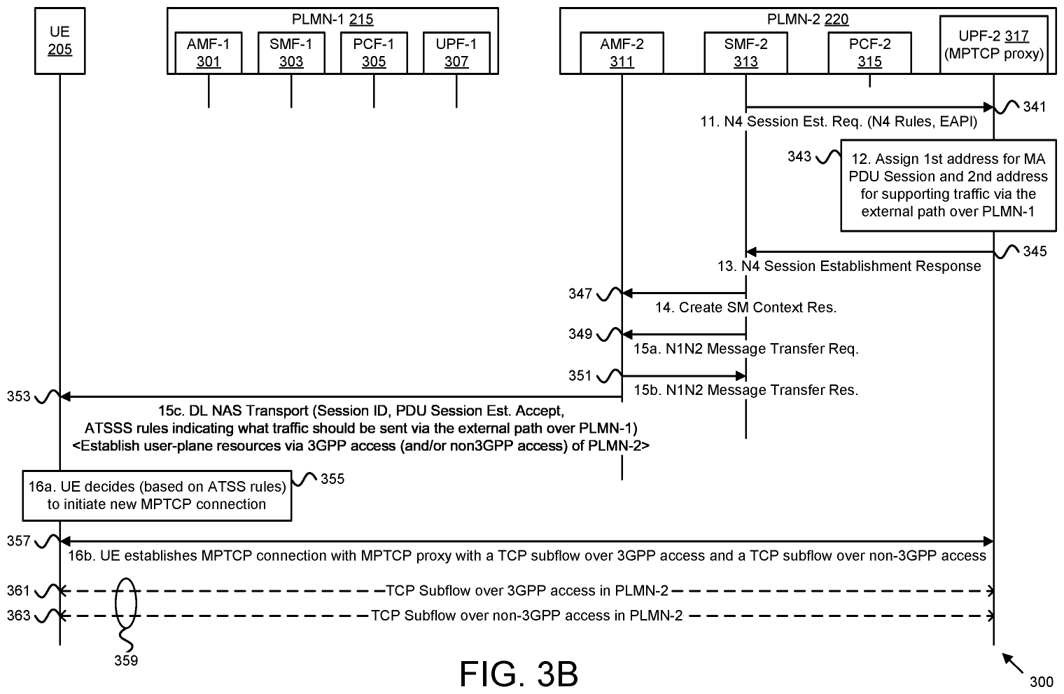

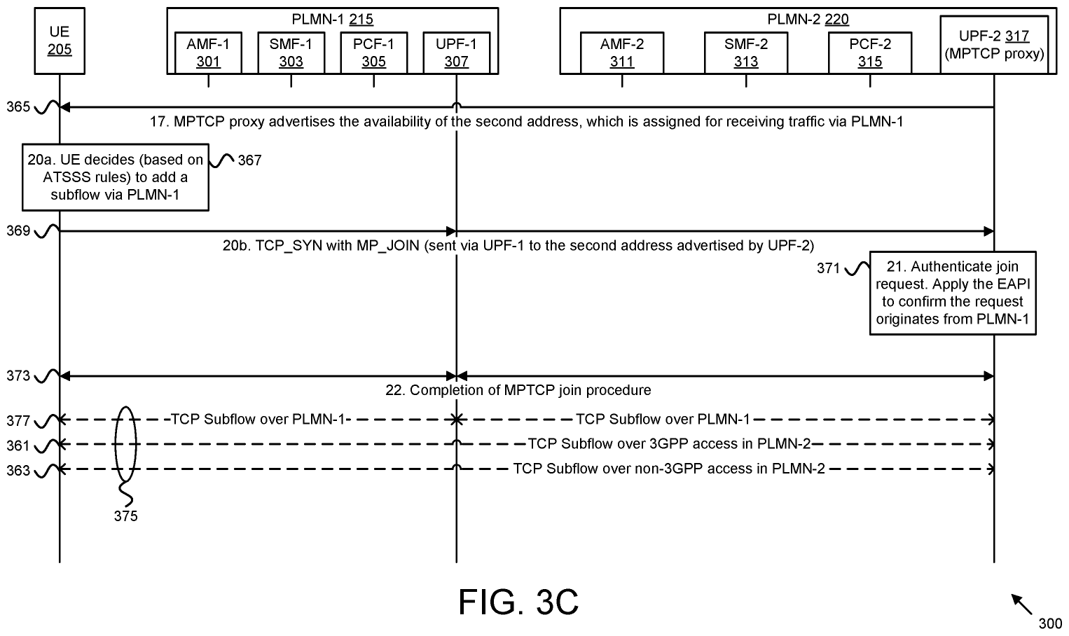

FIGS. 3A-3C depict a procedure 300 for establishing a multi-access data connection having an external access path over a different PLMN, according to embodiments of the disclosure. The procedure 300 involves the UE 205, a first AMF (denoted as “AMF-1”) 301 in the PLMN-1 215, a first SMF (denoted as “SMF-1”) 303 in the PLMN-1 215, a first PCF (denoted as “PCF-1”) 305 in the PLMN-1 215, a first UPF (denoted as “UPF-1”) 307 in the PLMN-1 215, a second AMF (denoted as “AMF-2”) 311 in the PLMN-2 220, a second SMF (denoted as “SMF-2”) 313 in the PLMN-2 220, a second PCF (denoted as “PCF-2”) 315 in the PLMN-2 220, and a second UPF (denoted as “UPF-2”) 317 in the PLMN-2 220. Note that the UPF-2 317 contains an MPTCP proxy that communicates with a MPTCP client in the UE 205.

According to the first solution, the UE 205 may first establish a single-access data connection (e.g., a single access PDU session) with a first PLMN (e.g., PLMN-1 215) and then establishes the multi-access data connection (e.g., a multi access PDU session) with a second PLMN (e.g., PLMN-2 220). As described below, this (e.g., MA PDU Session) is established so that it can support, not only access paths in the second PLMN (e.g., PLMN-2 220), but also an external access path over the first PLMN (e.g., PLMN-1 215).

Starting on FIG. 3A, the procedure 300 begins at Step 0a when, the UE 205 registers with PLMN-1 over non-3GPP access or over 3GPP access (such as 3GPP non-terrestrial access) (see messaging 321). Here, it is assumed that the UE 205 uses a first set of credentials and/or a first USIM (i.e., USIM-1 270) to register with the PLMN-1 215.

At Step 0b, subsequently, the UE 205 establishes a single access PDU Session over the PLMN-1 215 with type=IP (see messaging 323). For this PDU Session, the UE 205 is assigned an IP address, denoted as ‘IP@x.’

At Step 1, the UE 205 registers with the PLMN-2 220 over a 3GPP access network and/or over a non-3GPP access network (see messaging 325). Here, it is assumed that the UE 205 uses a second set of credentials and/or a second USIM (i.e., USIM-2 275) to register with the PLMN-2 220. In the depicted embodiment, the AMF-2 311 is allocated to serve this UE 205 in both access networks. It is assumed below that the UE 205 is registered with the PLMN-2 220 over both accesses, however, in other embodiments the UE 205 may be registered only over one of these accesses.

At Step 4, the UE 205 decides to establish a MA PDU Session with the PLMN-2 220, which is to be able to support an external access path over the PLMN-1 215 (see block 327).

At Step 5, the UE 205 requests the MA PDU Session by sending an UL NAS Transport message to the AMF-2 311, which contains an MA PDU Request indication and a PDU Session Establishment Request message (see messaging 329). In addition, the UL NAS Transport message contains an External Access Path Request (“EAPR”) element, which indicates that the UE 205 wants the MA PDU Session in the PLMN-2 220 to support an access path over the PLMN-1 215, i.e., an access path external to the PLMN-2 220, referred to as the external access path. The EAPR element contains the identity of the PLMN-1 215 and the IP address (i.e., IP@x) that will be used by the UE 205 to send traffic via the external access path.

In certain embodiments, the UE 205 may also include in the PDU Session Establishment Request message-either inside or outside the EAPR element—a first indication that specifies whether the UE 205 can support simultaneous transmission over the external access path and over an access path in the PLMN-2 220. This first indication can be considered by the PCF-2 315 later when creating the policy and charging control (“PCC”) rules for the MA PDU Session (e.g., in Step 9). For example, the first indication may specify that the UE 205 cannot support simultaneous transmission over the external access path and over the 3GPP terrestrial access path in the PLMN-2 220. As another example, the first indication may specify that the UE 205 does support simultaneous transmission over the external access path and over the non-3GPP terrestrial access path in the PLMN-2 220.

At Step 6, the AMF-2 311 selects an SMF in the PLMN-2 220 and sends to the selected SMF (i.e., the SMF-2 313) a Create Session Management (“SM”) Context Request message that contains the PDU Session Establishment Request and the EAPR element (see messaging 331).

At Step 7, in response, the SMF-2 313 selects a PCF in the PLMN-2 220 (i.e., the PCF-2 315) and sends to the selected PCF a SM Policy Control Create Request message containing the EAPR element (see messaging 333).

At Step 8, the PCF-2 315 determines, based on the EAPR element, that the UE 205 wants the requested MA PDU Session to support an access path over the PLMN-1 215 (see block 335). Based on local policy or configuration information, the PCF-2 315 decides to authorize the requested external access path for the MA PDU Session. In one example, this authorization may be granted because the local policy or configuration information indicates that external access paths over the PLMN-1 215 are allowed by the operator of the PLMN-2 220.

At Step 9, the PCF-2 315 creates SM policy for the requested MA PDU Session and a plurality of PCC rules, each one indicating how selected traffic should be routed across the access paths of the MA PDU Session in the PLMN-2 220 (see block 337). For example, a PCC rule may indicate that the traffic of a certain application (i.e., ‘app-X’) should be routed to the access path in the PLMN-2 220, which features the smallest delay across all access paths in the PLMN-2 220.

Additionally, a PCC rule may indicate what traffic should be routed via the external access path over the PLMN-1 215. As an example, a PCC rule may indicate that the traffic of a certain application (i.e., ‘app-Y’) should be equally distributed (i.e., 50:50 load balancing) between an access path in the PLMN-2 220 and the external access path in the PLMN-1 215. As a further example, a PCC rule may indicate that the traffic of a certain application (i.e., ‘app-Z”) should be sent over the external access path in the PLMN-1 215, when available, and, when not available, the traffic should be sent over an access path in the PLMN-2 220.

In some embodiments, the PCF-2 315 may consider the first indication provided by the UE 205 in Step 5, when creating the PCC rules. When present, this indication is transferred from the AMF-2 311 to the SMF-2 313 and then to the PCF-2 315.

At Step 10, the PCF-2 315 sends a SM Policy Control Create Response message to the SMF-2 313, which includes the created PCC rules and an External Access Path Info (“EAPI”) element (see messaging 339). The EAPI element comprises information that can be used to determine whether the traffic received via the external access path originates really from the PLMN-1 215. For example, the EAPI element may comprise a range of IP addresses, which the PLMN-1 215 allocates to PDU Sessions established in the PLMN-1 215. This range of IP addresses would contain the IP@x allocated to UE 205 in Step 0b.

Continuing on FIG. 3B, at Step 11, the SMF-2 313 selects a UPF and sends to the selected UPF (i.e., the UPF-2 317) an N4 Session Establishment Request message to reserve user-plane resources to support data communication for the requested MA PDU Session (see messaging 341). This N4 Session Establishment Request message contains the EAPI element received from the PCF-2 315 and N4 rules that indicate to the UPF-2 317 how to route the DL data traffic of the MA PDU Session across the access paths in the PLMN-2 220. In addition, an N4 rule may indicate what DL data traffic should be sent to UE 205 via the external access path over the PLMN-1 215. Note that the N4 rules are derived by the SMF-2 313 from the PCC rules received by the PCF-2 315.

At Step 12, the UPF-2 317 assigns an IP address (first address) for the MA PDU Session, as normally. Additionally, the UPF-2 317 may also assign a second address, which is to be used for communicating with the UE 205 via the external access path over the PLMN-1 215 (see block 343). In some embodiments, the second address may be different from the first address and may be used for communication with the UE 205 via the external access path. However, in other embodiments, the second address is the same as the first address. The UPF-2 317 decides whether the second address should be different than the first address based on local policy and configuration stored in the UPF-2 317 or based on an additional indication received from the SMF-2 313 in Step 11 (not shown in the figure).

At Step 13, the UPF-2 317 responds to the SMF-2 313 by sending an N4 Session Establishment Response message (see messaging 345). This message contains the first address assigned to the MA PDU Session (in Step 12) as well as other parameters, such as an MPTCP proxy address and port in the UPF-2 317, Measurement Assistance Information, etc.

At Step 14, the SMF-2 313 responds to the Create SM Context Request message sent by the AMF-2 311 (in Step 6) with a Create SM Context Response message (see messaging 347).

At Step 15a, the SMF-2 313 creates a PDU Session Establishment Accept message, embeds this message into an N1N2Message Transfer Request and sends it to the AMF-2 311 (see messaging 349).

At Step 15b, the AMF-2 311 responds by sending an N1N2Message Transfer Response message to the SMF-2 313 (see messaging 351).

At Step 15c, the AMF-2 311 also sends a DL NAS Transport message to UE 205 that contains an PDU Session Establishment Accept message (see messaging 353). The PDU Session Establishment Accept message contains ATSSS rules derived by the SMF-2 313 from the PCC rules received by the PCF-2 315. The ATSSS rules indicate to UE 205 how to route the UL data traffic of the MA PDU Session across the access paths in the PLMN-2 220. In addition, an ATSSS rule may indicate what UL data traffic should be sent to the UPF-2 317 via the external access path over the PLMN-1 215.

After Step 15, the user-plane resources across the access paths in the PLMN-2 220, e.g., across a 3GPP terrestrial access path and/or a non-3GPP access path, are established. Accordingly, multi-access data communication between the UE 205 and the UPF-2 317 can initiate across these access paths in the PLMN-2 220.

At Step 16a, the UE 205 wants to start communication with a remote host via the MA PDU Session in the PLMN-2 220. Based on the received ATSSS rules, the UE 205 determines that this communication should go through the MPTCP proxy in the UPF-2 317 (see block 355).

At Step 16b, the determination in UE 205 in Step 16a triggers the establishment of a new MPTCP connection between the UE 205 and the MPTCP proxy in the UPF-2 317 (see messaging 357). Here, the MPTCP connection 359 is configured to support a TCP sub-flow 361 over the 3GPP access path in the PLMN-2 220 and a TCP sub-flow 363 over the non-3GPP access path in the PLMN-2 220. Each TCP sub-flow carries part of the TCP traffic exchanged between the UE 205 and the remote host (i.e., remote host 265).

Note that in the UL direction, the MPTCP proxy combines the TCP traffic receives over the two access paths in the PLMN-2 220 (or the two TCP sub-flows) and forwards this traffic to the remote host. In the DL direction, the MPTCP proxy splits the TCP traffic receives from the remote host and forwards this traffic to the UE 205 across the two access paths in the PLMN-2 220 (or the two TCP sub-flows).

Continuing on FIG. 3C, because the UPF-2 317 received the EAPI element in Step 11 and assigned an IP address (second address) for supporting traffic via the external access path over the PLMN-1 215, at Step 17 the MPTCP proxy in the UPF-2 317 advertises the availability of the second address (see messaging 365). In various embodiments, the address availability advertisement is done by the address advertisements mechanisms supported by the MPTCP protocol, i.e., by sending a TCP packet to UE 205 including the ADD_ADDR option.

The address availability advertisement indicates to UE 205 that it can communicate with the MPTCP proxy by using also the second address. Note that, when an external access path for the MA PDU Session is not supported (as in prior art), the MPTCP proxy does not advertise additional addresses and does not send the advertisement message of Step 17. When the UE 205 receives the second address advertised by the MPTCP proxy, the UE 205 determines that the advertised second address can be used to communicate with the MPTCP proxy via the external access path over the PLMN-1 215.

At Step 20a, based on the ATSSS rules, the UE 205 determines that some traffic of the existing MPTCP connection should be sent via the external access path over the PLMN-1 215 (see block 367). For example, an ATSSS rule may specify that the traffic of a selected application should be split (e.g., load-balanced) across the two access paths in the PLMN-2 220 and the external access path.

At Step 20b, this ATSSS rule triggers the UE 205 to request the establishment of a TCP sub-flow with the MPTCP proxy via the external access path by sending a TCP_SYN packet to the second address of the UPF-2 317 (see messaging 369). This packet is sent via the PLMN-1 215 (i.e., via the radio access in the PLMN-1 215 and via UPF-1) and contains the MP JOIN option and other parameters specified in the MPTCP specification (see, e.g., RFC 8684). The MP JOIN indicates that the TCP sub-flow via the external path will join the existing MPTCP connection established in Step 16b.

At Step 21, the UPF-2 317 authenticates the join request sent by the UE 205 using the mechanisms specified in the MPTCP specification (see block 371). In addition, the UPF-2 317 applies the EAPI received in Step 11 to confirm that the join request originates really from the PLMN-1 215 (and not from another PLMN). For example, the UPF-2 317 may confirm that the source address of the received TCP_SYN packet is within the range of IP addresses contained in the EAPI element.

At Step 22, the MPTCP join procedure is completed (see messaging 373) and the MPTCP connection 375 between the UE 205 and the MPTCP proxy in the UPF-2 317 now has three paths: a first path over the 3GPP access path in the PLMN-2 220, a second path over the non-3GPP access path in the PLMN-2 220, and a third path over the external access path via the PLMN-1 215. Each access path carries a separate TCP sub-flow, hence, the MPTCP connection 375 is composed of three TCP sub-flows: the TCP sub-flow 361 over the 3GPP access path in the PLMN-2 220, the TCP sub-flow 363 over the non-3GPP access path in the PLMN-2 220, and a TCP sub-flow 377 over the external access path via the PLMN-1 215.

At this point, the traffic of the MPTCP connection between the UE 205 and the MPTCP proxy in the UPF-2 317 is exchanged across the above three access paths.

While the embodiments describe MPTCP connections and TCP sub-flows, in other embodiments the UE 205 establishes a multi-path connection using other types of multi-path protocols, such as multi-path QUIC, multi-path Datagram Congestion Control Protocol (“DCCP”), etc. For example, the UE 205 may establish a multi-path QUIC connection having a sub-flow over the 3GPP access path in the PLMN-2 220, a sub-flow over the non-3GPP access path in the PLMN-2 220, and a sub-flow over the external access path via the PLMN-1 215.

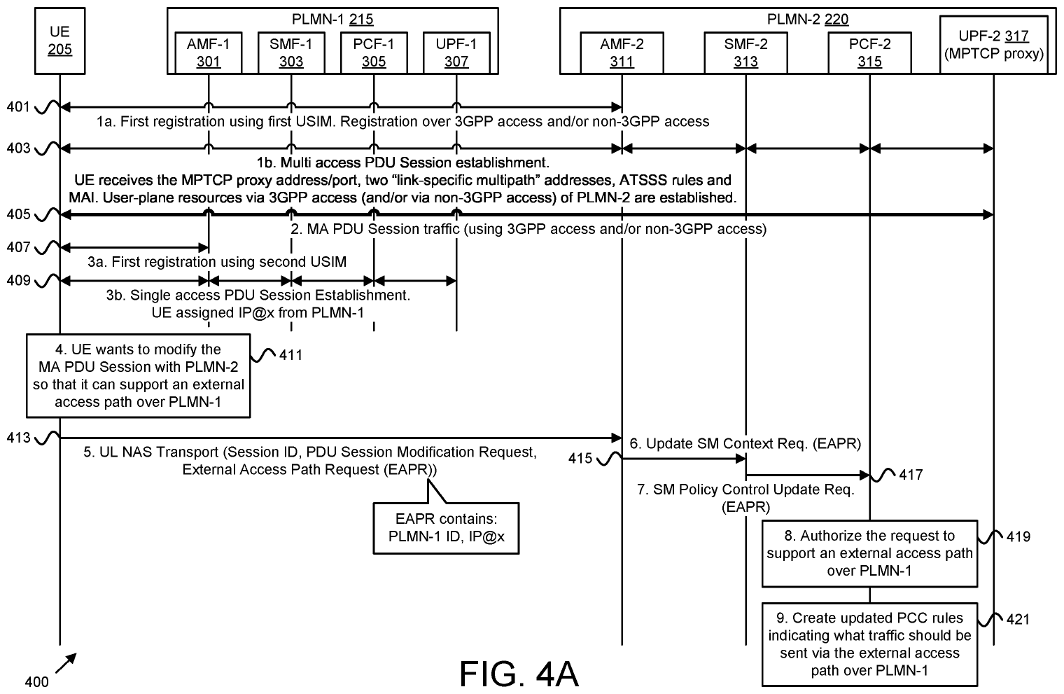

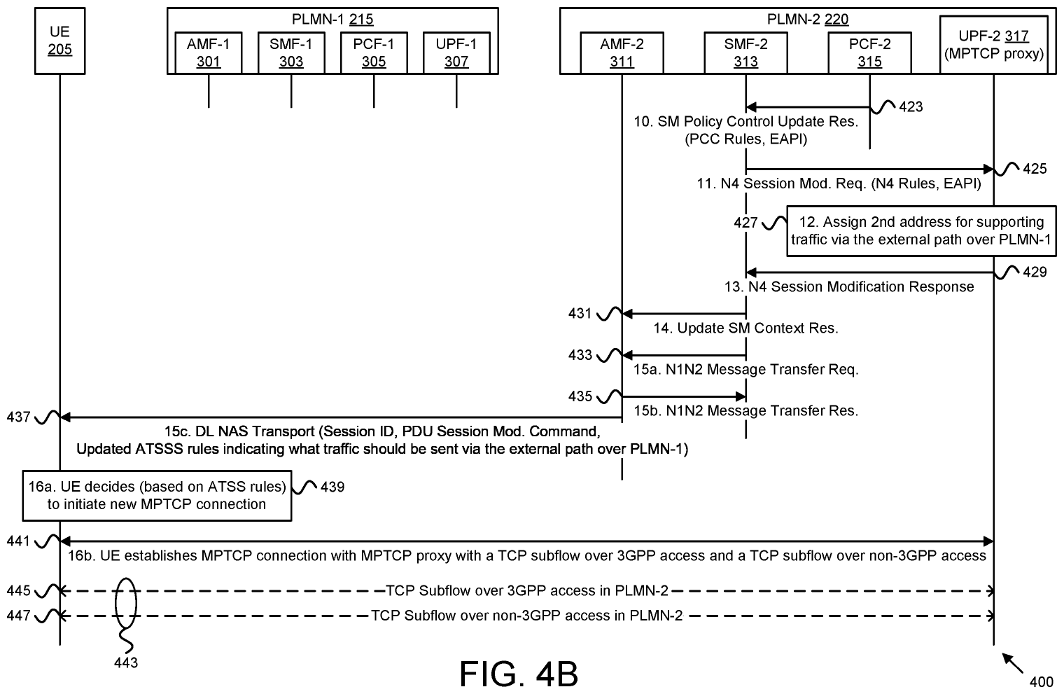

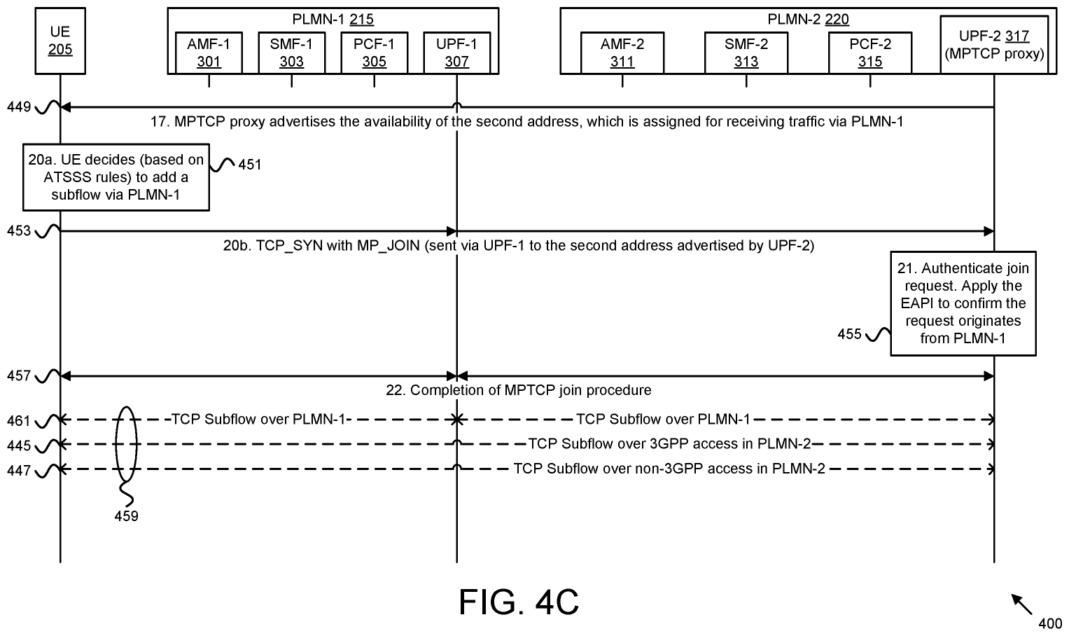

FIGS. 4A-4C depict a procedure 400 for modifying a multi-access data connection to support an external access path over a different PLMN, according to embodiments of the disclosure. The procedure 400 involves the UE 205, the AMF-1 301 in the PLMN-1 215, the SMF-1 303 in the PLMN-1 215, the PCF-1 305 in the PLMN-1 215, the UPF-1 307 in the PLMN-1 215, the AMF-2 311 in the PLMN-2 220, the SMF-2 313 in the PLMN-2 220, the PCF-2 315 in the PLMN-2 220, and the UPF-2 317 in the PLMN-2 220. Again, the UPF-2 317 contains an MPTCP proxy that communicates with a MPTCP client in the UE 205.

According to the second solution, the UE 205 may first establish the multi-access data connection (e.g., a multi access PDU session) with the PLMN-2 220 and then establish a single-access data connection (e.g., a single access PDU session) with the PLMN-1 215. Afterwards, the multi-access data connection (e.g., MA PDU Session) is modified so that it can also support an external access path over the PLMN-1 215.

Starting on FIG. 4A, the procedure 400 begins at Step 1a when the UE 205 registers with the PLMN-2 220 over a 3GPP access network and/or over a non-3GPP access network (see messaging 401). Here, it is assumed that the UE 205 uses a first set of credentials and/or a first USIM (i.e., USIM-2 275) to register with the PLMN-2 220. In the depicted embodiment, the AMF-2 311 is allocated to serve this UE 205 in both access networks. It is assumed below that the UE 205 is registered with the PLMN-2 220 over both accesses, however, in other embodiments the UE 205 may be registered only over one of these accesses.

At Step 1b, the UE 205 requests to establish an MA PDU Session in the PLMN-2 220 (see messaging 403). Here, the regular MA PDU Session establishment procedure specified in 3GPP Technical Specification (“TS”) 23.502 is applied. In this context, the UPF-2 317 assigns an IP address (first address) for the MA PDU Session and the UE 205 receives the MPTCP proxy address and port, the ATSSS rules, Measurement Assistance Information, etc. Additionally, user-plane resources are established over 3GPP access and non-3GPP access in the PLMN-2 220 to support multi-access data communication between the UE 205 and the UPF-2 317.

At Step 2, data communication takes place between the UE 205 and the UPF-2 317 across the 3GPP access path and the non-3GPP access path of the MA PDU Session (see messaging 405).

At Step 3a, the UE 205 registers with PLMN-1 over non-3GPP access or over 3GPP access (such as 3GPP non-terrestrial access) (see messaging 407). Here, it is assumed that the UE 205 uses a second set of credentials and/or a second USIM (i.e., USIM-1 270) to register with the PLMN-1 215.

At Step 3b, subsequently, the UE 205 establishes a single access PDU Session over the PLMN-1 215 with type=IP (see messaging 409). For this PDU Session, the UE 205 is assigned an IP address, denoted as ‘IP@x.’

At Step 4, the UE 205 decides to establish a MA PDU Session with the PLMN-2 220, which is to be able to support an external access path over the PLMN-1 215 (see block 411). This is to be accomplished by modifying the existing MA PDU Session with PLMN-2 220 to support the external access path.

At Step 5, the UE 205 requests the MA PDU Session by sending an UL NAS Transport message to the AMF-2 311, which contains an MA PDU Request indication and a PDU Session Modification Request message to modify the existing MA PDU Session established in Step 1b (see messaging 413). In addition, the UL NAS Transport message contains an External Access Path Request (“EAPR”) element, which indicates that the UE 205 wants the MA PDU Session in the PLMN-2 220 to support an access path over the PLMN-1 215, i.e., an access path external to the PLMN-2 220. The EAPR element contains the identity of the PLMN-1 215 and the IP address (i.e., IP@x) that will be used by the UE 205 to send traffic via the external access path.

In certain embodiments, the UE 205 may also include in the PDU Session Modification Request message-either inside or outside the EAPR element—a first indication that specifies whether the UE 205 can support simultaneous transmission over the external access path and over an access path in the PLMN-2 220. This first indication can be considered by the PCF-2 315 later when creating the PCC rules for the MA PDU Session (e.g., in Step 9). For example, the first indication may specify that the UE 205 cannot support simultaneous transmission over the external access path and over the 3GPP terrestrial access path in the PLMN-2 220. As another example, the first indication may specify that the UE 205 does support simultaneous transmission over the external access path and over the non-3GPP terrestrial access path in the PLMN-2 220.

At Step 6, the AMF-2 311 sends to the SMF-2 313 an Update Session Management (“SM”) Context Request message that contains the PDU Session Modification Request and the EAPR element (see messaging 415).

At Step 7, in response, the SMF-2 313 sends a SM Policy Control Create Request message containing the EAPR element to the PCF-2 315 (see messaging 417).

At Step 8, the PCF-2 315 determines, based on the EAPR element, that the UE 205 wants the requested MA PDU Session to support an access path over the PLMN-1 215 (see block 419). Based on local policy or configuration information, the PCF-2 315 decides to authorize the requested external access path for the MA PDU Session. In one example, this authorization may be granted because the local policy or configuration information indicates that external access paths over the PLMN-1 215 are allowed by the operator of the PLMN-2 220.

At Step 9, the PCF-2 315 creates updated SM policy for the requested MA PDU Session and updates the plurality of PCC rules, each one indicating how selected traffic should be routed across the access paths of the MA PDU Session in the PLMN-2 220 (see block 421). Here, an updated PCC rule may indicate what traffic should be routed via the external access path over the PLMN-1 215.

As an example, a PCC rule may indicate that the traffic of a certain application (i.e., ‘app-Y’) should be equally distributed (i.e., 50:50 load balancing) between an access path in the PLMN-2 220 and the external access path in the PLMN-1 215. As a further example, an updated PCC rule may indicate that the traffic of a certain application (i.e., ‘app-Z”) should be sent over the external access path in the PLMN-1 215, when available, and, when not available, the traffic should be sent over an access path in the PLMN-2 220.

In some embodiments, the PCF-2 315 may consider the first indication provided by the UE 205 in Step 5, when creating the PCC rules. When present, this indication is transferred from the AMF-2 311 to the SMF-2 313 and then to the PCF-2 315.

Continuing on FIG. 4B, at Step 10, the PCF-2 315 sends a SM Policy Control Update Response message to the SMF-2 313, which includes the updated PCC rules and an External Access Path Info (“EAPI”) element (see messaging 423). The EAPI element comprises information that can be used to determine whether the traffic received via the external access path originates really from the PLMN-1 215. For example, the EAPI element may comprise a range of IP addresses, which the PLMN-1 215 allocates to PDU Sessions established in the PLMN-1 215. This range of IP addresses would contain the IP@x allocated to UE 205 in Step 3b.

At Step 11, the SMF-2 313 sends to the UPF-2 317 an N4 Session Modification Request message to reserve user-plane resources to support data communication for the updated MA PDU Session (see messaging 425). This N4 Session Modification Request message contains the EAPI element received from the PCF-2 315 and N4 rules that indicate to the UPF-2 317 how to route the DL data traffic of the MA PDU Session across the access paths in the PLMN-2 220. In addition, an N4 rule may indicate what DL data traffic should be sent to UE 205 via the external access path over the PLMN-1 215. Note that the N4 rules are derived by the SMF-2 313 from the PCC rules received by the PCF-2 315.

At Step 12, the UPF-2 317 assigns a second IP address for the MA PDU Session, which is to be used for communicating with the UE 205 via the external access path over the PLMN-1 215 (see block 427). As described above, the second address may be the same or different from the first address. The UPF-2 317 decides whether the second address is to be different than the first address based on local policy and configuration stored in the UPF-2 317 or based on an additional indication received from the SMF-2 313 (e.g., in the N4 Session Modification Request).

At Step 13, the UPF-2 317 responds to the SMF-2 313 by sending an N4 Session Establishment Response message (see messaging 429). This message contains the first address assigned to the MA PDU Session (e.g., in Step 12) as well as other parameters, such as an MPTCP proxy address and port in the UPF-2 317, Measurement Assistance Information, etc.

At Step 14, the SMF-2 313 responds to the Update SM Context Request message sent by the AMF-2 311 (in Step 6) with an Update SM Context Response message (see messaging 431).

At Step 15a, the SMF-2 313 creates a PDU Session Modification Command message, embeds this message into an N1N2Message Transfer Request and sends it to the AMF-2 311 (see messaging 433).

At Step 15b, the AMF-2 311 responds by sending an N1N2Message Transfer Response message to the SMF-2 313 (see messaging 435).

At Step 15c, the AMF-2 311 also sends a DL NAS Transport message to UE 205 that contains an PDU Session Modification Command message (see messaging 437). The PDU Session Modification Command message contains ATSSS rules derived by the SMF-2 313 from the PCC rules received by the PCF-2 315. The ATSSS rules indicate to UE 205 how to route the UL data traffic of the MA PDU Session across the access paths in the PLMN-2 220. In addition, an ATSSS rule may indicate what UL data traffic should be sent to the UPF-2 317 via the external access path over the PLMN-1 215.

After Step 15, the user-plane resources across the access paths in the PLMN-2 220, e.g., across a 3GPP terrestrial access path and/or a non-3GPP access path, are established.

Accordingly, multi-access data communication between the UE 205 and the UPF-2 317 can initiate across these access paths in the PLMN-2 220.

At Step 16a, the UE 205 wants to start communication with a remote host via the MA PDU Session in the PLMN-2 220. Based on the received ATSSS rules, the UE 205 determines that this communication should go through the MPTCP proxy in the UPF-2 317 (see block 439).

At Step 16b, the determination in UE 205 in Step 16a triggers the establishment of a new MPTCP connection between the UE 205 and the MPTCP proxy in the UPF-2 317 (see messaging 441). Here, the MPTCP connection 443 is configured to support a TCP sub-flow 445 over the 3GPP access path in the PLMN-2 220 and a TCP sub-flow 447 over the non-3GPP access path in the PLMN-2 220. Each TCP sub-flow carries part of the TCP traffic exchanged between the UE 205 and the remote host (i.e., remote host 265).

Note that in the UL direction, the MPTCP proxy combines the TCP traffic receives over the two access paths in the PLMN-2 220 (or the two TCP sub-flows) and forwards this traffic to the remote host. In the DL direction, the MPTCP proxy splits the TCP traffic receives from the remote host and forwards this traffic to the UE 205 across the two access paths in the PLMN-2 220 (or the two TCP sub-flows).

Continuing on FIG. 4C, because the UPF-2 317 received the EAPI element in Step 11 and assigned an IP address (second address) for supporting traffic via the external access path over the PLMN-1 215, at Step 17 the MPTCP proxy in the UPF-2 317 advertises the availability of the second address (see messaging 449). In various embodiments, the address availability advertisement is done by the address advertisements mechanisms supported by the MPTCP protocol, i.e., by sending a TCP packet to UE 205 including the ADD_ADDR option.

The address availability advertisement indicates to UE 205 that it can communicate with the MPTCP proxy by using also the second address. When the UE 205 receives the second address advertised by the MPTCP proxy, the UE 205 determines that the advertised second address can be used to communicate with the MPTCP proxy via the external access path over the PLMN-1 215.

At Step 20a, based on the ATSSS rules, the UE 205 determines that some traffic of the existing MPTCP connection should be sent via the external access path over the PLMN-1 215 (see block 451). For example, an ATSSS rule may specify that the traffic of a selected application should be split (e.g., load-balanced) across the two access paths in the PLMN-2 220 and the external access path.

At Step 20b, this ATSSS rule triggers the UE 205 to request the establishment of a TCP sub-flow with the MPTCP proxy via the external access path by sending a TCP_SYN packet to the second address of the UPF-2 317 (see messaging 453). This packet is sent via the PLMN-1 215 (i.e., via the radio access in the PLMN-1 215 and via UPF-1) and contains the MP_JOIN option and other parameters specified in the MPTCP specification (see, e.g., RFC 8684). The MP JOIN indicates that the TCP sub-flow via the external path will join the existing MPTCP connection established in Step 16b.

At Step 21, the UPF-2 317 authenticates the join request sent by the UE 205 using the mechanisms specified in the MPTCP specification (see block 455). In addition, the UPF-2 317 applies the EAPI received in Step 11 to confirm that the join request originates really from the PLMN-1 215 (and not from another PLMN). For example, the UPF-2 317 may confirm that the source address of the received TCP_SYN packet is within the range of IP addresses contained in the EAPI element.

At Step 22, the MPTCP join procedure is completed (see messaging 457) and the MPTCP connection 459 between the UE 205 and the MPTCP proxy in the UPF-2 317 now has three paths: a first path over the 3GPP access path in the PLMN-2 220, a second path over the non-3GPP access path in the PLMN-2 220, and a third path over the external access path via the PLMN-1 215. Each access path carries a separate TCP sub-flow, hence, the MPTCP connection 459 is composed of three TCP sub-flows: the TCP sub-flow 445 over the 3GPP access path in the PLMN-2 220, the TCP sub-flow 447 over the non-3GPP access path in the PLMN-2 220, and a TCP sub-flow 461 over the external access path via the PLMN-1 215.

At this point, the traffic of the MPTCP connection between the UE 205 and the MPTCP proxy in the UPF-2 317 is exchanged across the above three access paths.

While the embodiments describe MPTCP connections and TCP sub-flows, in other embodiments the UE 205 establishes a multi-path connection using other types of multi-path protocols, such as multi-path QUIC, multi-path DCCP, etc. For example, the UE 205 may establish a multi-path QUIC connection having a sub-flow over the 3GPP access path in the PLMN-2 220, a sub-flow over the non-3GPP access path in the PLMN-2 220, and a sub-flow over the external access path via the PLMN-1 215.

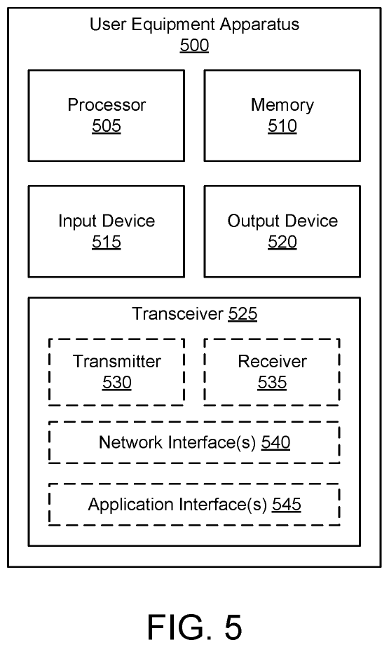

FIG. 5 depicts one embodiment of a user equipment apparatus 500 that may be used for establishing a multi-access data connection with an external access path, according to embodiments of the disclosure. The user equipment apparatus 500 may be one embodiment of the remote unit 105 and/or the UE 205. Furthermore, the user equipment apparatus 500 may include a processor 505, a memory 510, an input device 515, an output device 520, a transceiver 525.

In some embodiments, the input device 515 and the output device 520 are combined into a single device, such as a touchscreen. In certain embodiments, the user equipment apparatus 500 may not include any input device 515 and/or output device 520. In various embodiments, the user equipment apparatus 500 may include one or more of: the processor 505, the memory 510, and the transceiver 525, and may not include the input device 515 and/or the output device 520.

As depicted, the transceiver 525 includes at least one transmitter 530 and at least one receiver 535. In some embodiments, the transceiver 525 communicates with one or more cells (or wireless coverage areas) supported by one or more satellites 113, terrestrial base units 131, and/or access points 141. In various embodiments, the transceiver 525 is operable on unlicensed spectrum. Moreover, the transceiver 525 may include multiple UE panels supporting one or more beams. Additionally, the transceiver 525 may support at least one network interface 540 and/or application interface 545. The application interface(s) 545 may support one or more APIs. The network interface(s) 540 may support 3GPP reference points, such as Uu, N1, PC5, etc. Other network interfaces 540 may be supported, as understood by one of ordinary skill in the art.

The processor 505, in one embodiment, may include any known controller capable of executing computer-readable instructions and/or capable of performing logical operations. For example, the processor 505 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 505 executes instructions stored in the memory 510 to perform the methods and routines described herein. The processor 505 is communicatively coupled to the memory 510, the input device 515, the output device 520, and the transceiver 525.

In various embodiments, the processor 505 controls the user equipment apparatus 500 to implement the above described UE behaviors. In certain embodiments, the processor 505 may include an application processor (also known as “main processor”) which manages application-domain and operating system (“OS”) functions and a baseband processor (also known as “baseband radio processor”) which manages radio functions.

In some embodiments, the transceiver 525 communicates (i.e., using a radio interface) with a first mobile communication network and a second mobile communication network via a plurality of access networks. In various embodiments, the processor 505 registers the apparatus 500 with both the first mobile communication network (e.g., a first PLMN) and the second mobile communication network (e.g., a second PLMN). In certain embodiments, the processor 505 registers with the first mobile communication network using a set of credentials (e.g., using a first USIM) and registers with the second mobile communication network using a second set of credentials (e.g., using a second USIM).

The processor 505 sends a first request message to the first mobile communication network (e.g., to PLMN-2 220) to establish a multi-access data connection. Here, the first request message includes an external access path request (“EAPR”) that indicates that the multi-access data connection is to support communication via the second mobile communication network (e.g., via PLMN-1 215). In some embodiments, the first request message includes an identity of the second mobile communication network and an IP address assigned by the second mobile communication network (e.g., “IP@x”). This IP address is assigned when a data connection with the second mobile communication network (e.g., a single-access data connection) is created.

In certain embodiments, the processor 505 establishes a single-access data connection with the second mobile communication network prior to establishing the multi-access data connection with the first mobile communication network. In such embodiments, the first request message comprises a MA PDU Session Establishment request. In other embodiments, the processor 505 establishes a single-access data connection with the second mobile communication network after establishing the multi-access data connection with the second mobile communication network. In such embodiments, the first request message comprises a MA PDU Session Modification request.

Via the transceiver 525, the processor 505 receives a response message from the first mobile communication network that accepts the request to establish a multi-access data connection. Here, the response message includes a set of rules (e.g., ATSSS rules) that indicate how the apparatus is to route data traffic across a set of access networks in the first mobile communication network and across an external access path over the second mobile communication network.

Additionally, the processor 505 communicates with a UPF in the first mobile communication network via the set of access networks and the external access path. In some embodiments, communicating with the UPF in the first mobile communication network via the set of access networks and the external access path includes the processor 505 establishing a MPTCP connection with the UPF, where the MPTCP connection supports a set of TCP sub-flows, each TCP sub-flow carrying TCP traffic over a different access network in the first mobile communication network.

In such embodiments, the processor 505 receives a first address advertised by the UPF and sends a request to add a new TCP sub-flow to the MPTCP connection, where the new TCP sub-flow is to carry TCP traffic over the access network in the second mobile communication network. Here, the first address is advertised in response to the multi-access data connection supporting communication via the second mobile communication network and the request to add a new TCP sub-flow is sent to the first address via an access network in the second mobile communication network.

The memory 510, in one embodiment, is a computer readable storage medium. In some embodiments, the memory 510 includes volatile computer storage media. For example, the memory 510 may include a RAM, including dynamic RAM (“DRAM”), synchronous dynamic RAM (“SDRAM”), and/or static RAM (“SRAM”). In some embodiments, the memory 510 includes non-volatile computer storage media. For example, the memory 510 may include a hard disk drive, a flash memory, or any other suitable non-volatile computer storage device. In some embodiments, the memory 510 includes both volatile and non-volatile computer storage media.

In some embodiments, the memory 510 stores data related to establishing a multipath unicast link and/or mobile operation. For example, the memory 510 may store various parameters, panel/beam configurations, resource assignments, policies, and the like as described above. In certain embodiments, the memory 510 also stores program code and related data, such as an operating system or other controller algorithms operating on the apparatus 500.

The input device 515, in one embodiment, may include any known computer input device including a touch panel, a button, a keyboard, a stylus, a microphone, or the like. In some embodiments, the input device 515 may be integrated with the output device 520, for example, as a touchscreen or similar touch-sensitive display. In some embodiments, the input device 515 includes a touchscreen such that text may be input using a virtual keyboard displayed on the touchscreen and/or by handwriting on the touchscreen. In some embodiments, the input device 515 includes two or more different devices, such as a keyboard and a touch panel.

The output device 520, in one embodiment, is designed to output visual, audible, and/or haptic signals. In some embodiments, the output device 520 includes an electronically controllable display or display device capable of outputting visual data to a user. For example, the output device 520 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 520 may include a wearable display separate from, but communicatively coupled to, the rest of the user equipment apparatus 500, such as a smart watch, smart glasses, a heads-up display, or the like. Further, the output device 520 may be a component of a smart phone, a personal digital assistant, a television, a table computer, a notebook (laptop) computer, a personal computer, a vehicle dashboard, or the like.

In certain embodiments, the output device 520 includes one or more speakers for producing sound. For example, the output device 520 may produce an audible alert or notification (e.g., a beep or chime). In some embodiments, the output device 520 includes one or more haptic devices for producing vibrations, motion, or other haptic feedback. In some embodiments, all or portions of the output device 520 may be integrated with the input device 515. For example, the input device 515 and output device 520 may form a touchscreen or similar touch-sensitive display. In other embodiments, the output device 520 may be located near the input device 515.

The transceiver 525 communicates with one or more network functions of a mobile communication network via one or more access networks. The transceiver 525 operates under the control of the processor 505 to transmit messages, data, and other signals and also to receive messages, data, and other signals. For example, the processor 505 may selectively activate the transceiver 525 (or portions thereof) at particular times in order to send and receive messages.

The transceiver 525 includes at least transmitter 530 and at least one receiver 535. One or more transmitters 530 may be used to provide UL communication signals to a non-terrestrial base unit 111 (via satellite 113), a terrestrial base unit 131 and/or an access point 141, such as the UL transmissions described herein. Similarly, one or more receivers 535 may be used to receive DL communication signals from the non-terrestrial base unit 111 (via satellite 113), the terrestrial base unit 131 and/or an access point 141, as described herein. Although only one transmitter 530 and one receiver 535 are illustrated, the user equipment apparatus 500 may have any suitable number of transmitters 530 and receivers 535. Further, the transmitter(s) 530 and the receiver(s) 535 may be any suitable type of transmitters and receivers. In one embodiment, the transceiver 525 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 525, transmitters 530, and receivers 535 may be implemented as physically separate components that access a shared hardware resource and/or software resource, such as for example, the network interface 540.

In various embodiments, one or more transmitters 530 and/or one or more receivers 535 may be implemented and/or integrated into a single hardware component, such as a multi-transceiver chip, a system-on-a-chip, an Application-Specific Integrated Circuit (“ASIC”), or other type of hardware component. In certain embodiments, one or more transmitters 530 and/or one or more receivers 535 may be implemented and/or integrated into a multi-chip module. In some embodiments, other components such as the network interface 540 or other hardware components/circuits may be integrated with any number of transmitters 530 and/or receivers 535 into a single chip. In such embodiment, the transmitters 530 and receivers 535 may be logically configured as a transceiver 525 that uses one more common control signals or as modular transmitters 530 and receivers 535 implemented in the same hardware chip or in a multi-chip module.

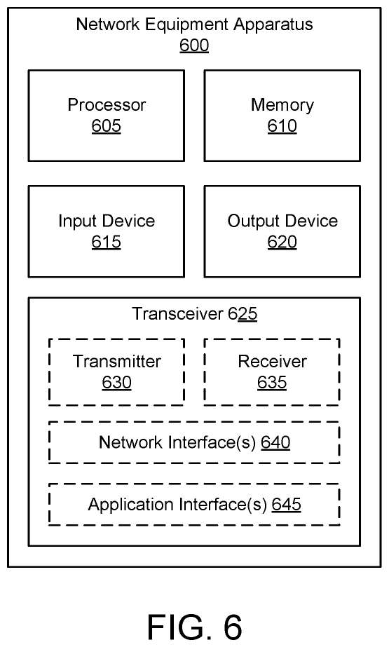

FIG. 6 depicts one embodiment of a network apparatus 600 that may be used for establishing a multi-access data connection with an external access path, according to embodiments of the disclosure. In some embodiments, the network apparatus 600 may implement a PCF. In other embodiments, the network apparatus 600 may implement a UPF. In further embodiments, the network apparatus 600 may implement an SMF. Furthermore, network apparatus 600 may include a processor 605, a memory 610, an input device 615, an output device 620, a transceiver 625.

In some embodiments, the input device 615 and the output device 620 are combined into a single device, such as a touchscreen. In certain embodiments, the network apparatus 600 may not include any input device 615 and/or output device 620. In various embodiments, the network apparatus 600 may include one or more of: the processor 605, the memory 610, and the transceiver 625, and may not include the input device 615 and/or the output device 620.

As depicted, the transceiver 625 includes at least one transmitter 630 and at least one receiver 635. Here, the transceiver 625 communicates with one or more remote units 105. Additionally, the transceiver 625 may support at least one network interface 640 and/or application interface 645. The application interface(s) 645 may support one or more APIs. The network interface(s) 640 may support 3GPP reference points, such as Uu, N1, N2 and N3. Other network interfaces 640 may be supported, as understood by one of ordinary skill in the art.

The processor 605, in one embodiment, may include any known controller capable of executing computer-readable instructions and/or capable of performing logical operations. For example, the processor 605 may be a microcontroller, a microprocessor, a CPU, a GPU, an auxiliary processing unit, a FPGA, or similar programmable controller. In some embodiments, the processor 605 executes instructions stored in the memory 610 to perform the methods and routines described herein. The processor 605 is communicatively coupled to the memory 610, the input device 615, the output device 620, and the transceiver 625.

In various embodiments, the network apparatus 600 is a RAN node (e.g., gNB) that communicates with one or more UEs, as described herein. In such embodiments, the processor 605 controls the network apparatus 600 to perform the above described RAN behaviors. When operating as a RAN node, the processor 605 may include an application processor (also known as “main processor”) which manages application-domain and operating system (“OS”) functions and a baseband processor (also known as “baseband radio processor”) which manages radio functions.

In various embodiments, the network apparatus 600 is a PCF (e.g., PCF 127, PCF 157, PCF-1 305, and/or PCF-2 315) that communicates with one or more NFs in a mobile communication network, as described herein. In such embodiments, the processor 605 controls the network apparatus 600 to perform the above described PCF behaviors.

In some embodiments, the transceiver 625 receives (i.e., via a network interface 640) a policy request for a multi-access data connection (e.g., a MA PDU session) of a UE, where the policy request contains an external access path request (“EAPR”) that indicates that the multi-access data connection is to support communication via a second mobile communication network (e.g., PLMN-1 215). The processor 605 generates a set of rules (e.g., PCC rules) and sends a response message to a session management function. Here, the set of rules indicate how the data traffic of the multi-access data connection is to be routed across a set of access networks in the first mobile communication network and across an external access path over the second mobile communication network and the response message contains the set of rules.

In some embodiments, the EAPR includes an identity of the second mobile communication network, where the processor 605 authorizes the external access path request for the multi-access data connection. In certain embodiments, authorizing the external access path request includes determining that external access paths over the second mobile communication network (e.g., the PLMN-1 215) are allowed by an operator of the first mobile communication network (e.g., the PLMN-2 220). In one embodiment, the authorization is based on local policy. In another embodiment, the authorization is based on configuration information.

In some embodiments, the policy request contains an indication (i.e., inside or outside the EAPR) of whether the UE supports simultaneous transmission via the first and second mobile communication networks (i.e., whether it can support simultaneous transmission over the external access path and over an access path in PLMN-2). In such embodiments, the set of rules is generated based on the indication. In some embodiments, the processor 605 further creates an external access path information (“EAPI”) element for validating an external access path over the second mobile communication network. In such embodiments, the response message further includes the EAPI element.

In various embodiments, the network apparatus 600 is a UPF (e.g., UPF 121, UPF 151, UPF-A 210, UPF-1 307, and/or UPF-2 317) that communicates with one or more NFs in a mobile communication network, as described herein. In such embodiments, the processor 605 controls the network apparatus 600 to perform the above described UPF behaviors.

In some embodiments, the transceiver 625 receives (i.e., via a network interface 640) a session establishment request for a multi-access data connection (e.g., a MA PDU session) of a UE, where the session establishment request contains a set of rules (e.g., N4 rules) for routing downlink traffic of the multi-access data connection across a first set of access networks in the first mobile communication network and across an external access path over a second mobile communication network. Note that the external access path may comprise a second set of access networks in the second mobile communication network.

The processor 605 assigns a first network address to the multi-access data connection for enabling UE communication via the first set of access networks in the first mobile communication network and assigns a second network address to the multi-access data connection for communicating with the UE via the external access path over the second mobile communication network. Using the transceiver 625, the processor 605 communicates with the UE via the first set of access networks and the external access path. Note that the first address is not used for UE-UPF communication. Rather, it is the address used by the UE to communicate with the Remote Host via the multi-access data connection. In contrast, the second address is used for UE-UPF communication via the second network.

In some embodiments, communicating with the UE via the first set of access networks and the external access path includes establishing a MPTCP connection with the UE and advertising availability of the second address to the UE. Here, the MPTCP connection supports a first set of TCP sub-flows, each TCP sub-flow carrying TCP traffic over a different access network in the first mobile communication network. In such embodiments, the second address is advertised in response to the multi-access data connection supporting communication via the second mobile communication network. In certain embodiments, the second address is the same as the first address.

In certain embodiments, the session establishment request further contains an EAPI element for validating the external access path over the second mobile communication network. In such embodiments, the processor 605 uses the EAPI element to validate that a request to add a new TCP sub-flow to the MPTCP is sent via the second mobile communication network and accepts the new TCP sub-flow in response to validating the request, where the new TCP sub-flow is to carry TCP traffic over an access network in the second mobile communication network.

In various embodiments, the network apparatus 600 is a SMF (e.g., SMF 125, SMF 155, SMF-1 303, and/or SMF-2 313) that communicates with one or more NFs in a mobile communication network, as described herein. In such embodiments, the processor 605 controls the network apparatus 600 to perform the above described SMF behaviors.

In some embodiments, the transceiver 625 communicates (i.e., via a network interface) with at least one network function in the first mobile communication network (e.g., the PLMN-2 220). The processor 605 receives a session request (e.g., a Create SM Context request or an Update SM Context request) for a multi-access data connection (e.g., a MA PDU session) of a UE and sends a policy request to a PCF. Here, both the session request and the policy request contain an external access path request that indicates that the multi-access data connection is to support communication via a second mobile communication network.

The processor 605 further receives a policy response from the PCF, the policy response comprising a first set of rules (e.g., PCC rules) and sends a session establishment request to a UPF, where the session establishment request message contains a second set of rules (e.g., N4 rules) for routing downlink traffic across a first set of access networks in the first mobile communication network and across an external access path over the second mobile communication network.

The processor 605 additionally sends a session response message (e.g., a Create SM Context response or an Update SM Context response) that contains a third set of rules (e.g., ATSSS rules) for routing uplink traffic across the first set of access networks in the first mobile communication network and across the external access path over the second mobile communication network. Note that the external access path may comprise a second set of access networks in the second mobile communication network.

In some embodiments, the policy response includes an EAPI element for validating an external access path over the second mobile communication network. In such embodiments, the session establishment request contains the EAPI.

The memory 610, in one embodiment, is a computer readable storage medium. In some embodiments, the memory 610 includes volatile computer storage media. For example, the memory 610 may include a RAM, including dynamic RAM (“DRAM”), synchronous dynamic RAM (“SDRAM”), and/or static RAM (“SRAM”). In some embodiments, the memory 610 includes non-volatile computer storage media. For example, the memory 610 may include a hard disk drive, a flash memory, or any other suitable non-volatile computer storage device. In some embodiments, the memory 610 includes both volatile and non-volatile computer storage media.

In some embodiments, the memory 610 stores data related to establishing a multipath unicast link and/or mobile operation. For example, the memory 610 may store parameters, configurations, resource assignments, policies, and the like, as described above. In certain embodiments, the memory 610 also stores program code and related data, such as an operating system or other controller algorithms operating on the apparatus 600.

The input device 615, in one embodiment, may include any known computer input device including a touch panel, a button, a keyboard, a stylus, a microphone, or the like. In some embodiments, the input device 615 may be integrated with the output device 620, for example, as a touchscreen or similar touch-sensitive display. In some embodiments, the input device 615 includes a touchscreen such that text may be input using a virtual keyboard displayed on the touchscreen and/or by handwriting on the touchscreen. In some embodiments, the input device 615 includes two or more different devices, such as a keyboard and a touch panel.

The output device 620, in one embodiment, is designed to output visual, audible, and/or haptic signals. In some embodiments, the output device 620 includes an electronically controllable display or display device capable of outputting visual data to a user. For example, the output device 620 may include, but is not limited to, an LCD display, an LED display, an OLED display, a projector, or similar display device capable of outputting images, text, or the like to a user. As another, non-limiting, example, the output device 620 may include a wearable display separate from, but communicatively coupled to, the rest of the network apparatus 600, such as a smart watch, smart glasses, a heads-up display, or the like. Further, the output device 620 may be a component of a smart phone, a personal digital assistant, a television, a table computer, a notebook (laptop) computer, a personal computer, a vehicle dashboard, or the like.

In certain embodiments, the output device 620 includes one or more speakers for producing sound. For example, the output device 620 may produce an audible alert or notification (e.g., a beep or chime). In some embodiments, the output device 620 includes one or more haptic devices for producing vibrations, motion, or other haptic feedback. In some embodiments, all or portions of the output device 620 may be integrated with the input device 615. For example, the input device 615 and output device 620 may form a touchscreen or similar touch-sensitive display. In other embodiments, the output device 620 may be located near the input device 615.

The transceiver 625 includes at least transmitter 630 and at least one receiver 635. One or more transmitters 630 may be used to communicate with the UE, as described herein. Similarly, one or more receivers 635 may be used to communicate with network functions in the PLMN and/or RAN, as described herein. Although only one transmitter 630 and one receiver 635 are illustrated, the network apparatus 600 may have any suitable number of transmitters 630 and receivers 635. Further, the transmitter(s) 630 and the receiver(s) 635 may be any suitable type of transmitters and receivers.

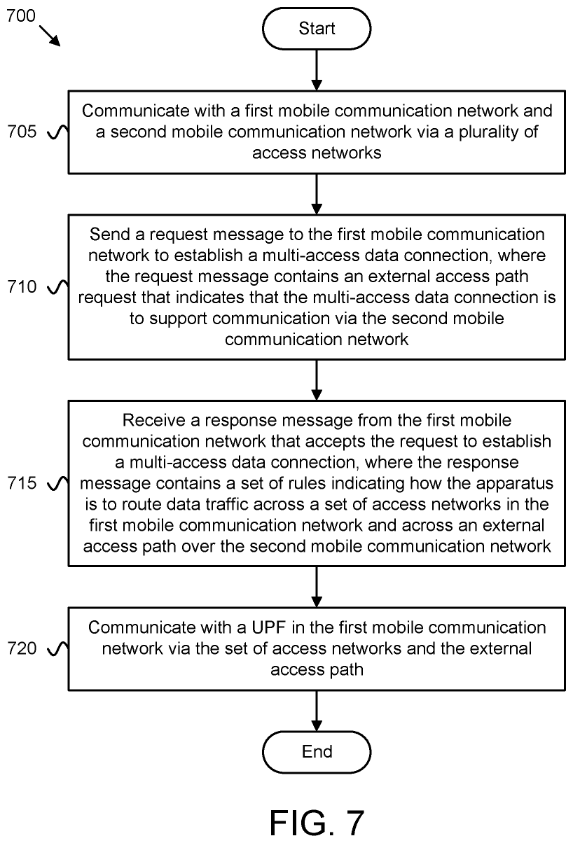

FIG. 7 depicts one embodiment of a method 700 for establishing a multi-access data connection with an external access path, according to embodiments of the disclosure. In various embodiments, the method 700 is performed by a user equipment device, such as the remote unit 105, the UE 205, and/or the user equipment apparatus 500, as described above. In some embodiments, the method 700 is performed by a processor, such as a microcontroller, a microprocessor, a CPU, a GPU, an auxiliary processing unit, a FPGA, or the like.

The method 700 begins and communicates 705 with a first mobile communication network and a second mobile communication network via a plurality of access networks. The method 700 includes sending 710 a request message to the first mobile communication network to establish a multi-access data connection, where the request message contains an external access path request that indicates that the multi-access data connection is to support communication via the second mobile communication network. The method 700 includes receiving 715 a response message from the first mobile communication network that accepts the request to establish a multi-access data connection, where the response message contains a set of rules (e.g., ATSSS rules) indicating how the apparatus is to route data traffic across a set of access networks in the first mobile communication network and across an external access path over the second mobile communication network. The method 700 includes communicating 720 with a user plane function (“UPF”) in the first mobile communication network via the set of access networks and the external access path. The method 700 ends.

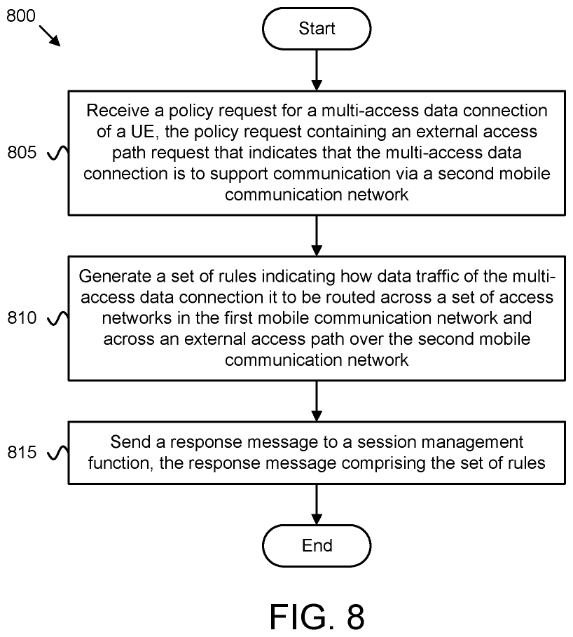

FIG. 8 depicts one embodiment of a method 800 for establishing a multi-access data connection with an external access path, according to embodiments of the disclosure. In various embodiments, the method 800 is performed by a policy control function, such as the PCF 157, the PCF-2 315, and/or the network apparatus 600, as described above. In some embodiments, the method 800 is performed by a processor, such as a microcontroller, a microprocessor, a CPU, a GPU, an auxiliary processing unit, a FPGA, or the like.

The method 800 begins and receives 805 a policy request for a multi-access data connection (e.g., MA PDU session) of a UE, the policy request containing an external access path request that indicates that the multi-access data connection is to support communication via a second mobile communication network. The method 800 includes generating 810 a set of rules (e.g., PCC rules) indicating how data traffic of the multi-access data connection it to be routed across a set of access networks in the first mobile communication network and across an external access path over the second mobile communication network. The method 800 includes sending 815 a response message to a session management function, the response message comprising the set of rules. The method 800 ends.

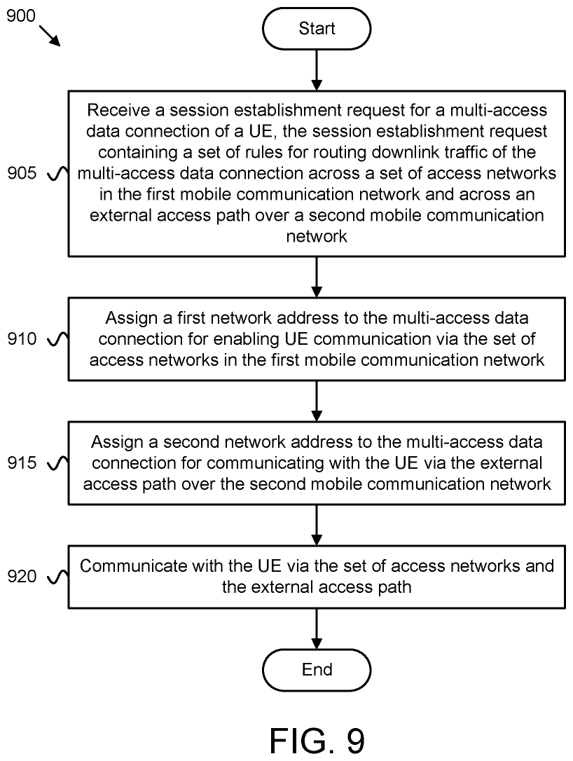

FIG. 9 depicts one embodiment of a method 900 for establishing a multi-access data connection with an external access path, according to embodiments of the disclosure. In various embodiments, the method 900 is performed by a user plane function, such as the UPF 151, the UPF-2 317, and/or the network apparatus 600, as described above. In some embodiments, the method 900 is performed by a processor, such as a microcontroller, a microprocessor, a CPU, a GPU, an auxiliary processing unit, a FPGA, or the like.

The method 900 begins and receives 905 a session establishment request for a multi-access data connection (e.g., MA PDU session) of a UE, the session establishment request containing a set of rules (e.g., N4 rules) for routing downlink traffic of the multi-access data connection across a set of access networks in the first mobile communication network and across an external access path over a second mobile communication network. The method 900 includes assigning 910 a first network address to the multi-access data connection for enabling UE communication via the set of access networks in the first mobile communication network. The method 900 includes assigning 915 a second network address to the multi-access data connection for communicating with the UE via the external access path over the second mobile communication network. The method 900 includes communicating 920 with the UE via the set of access networks and the external access path. The method 900 ends.

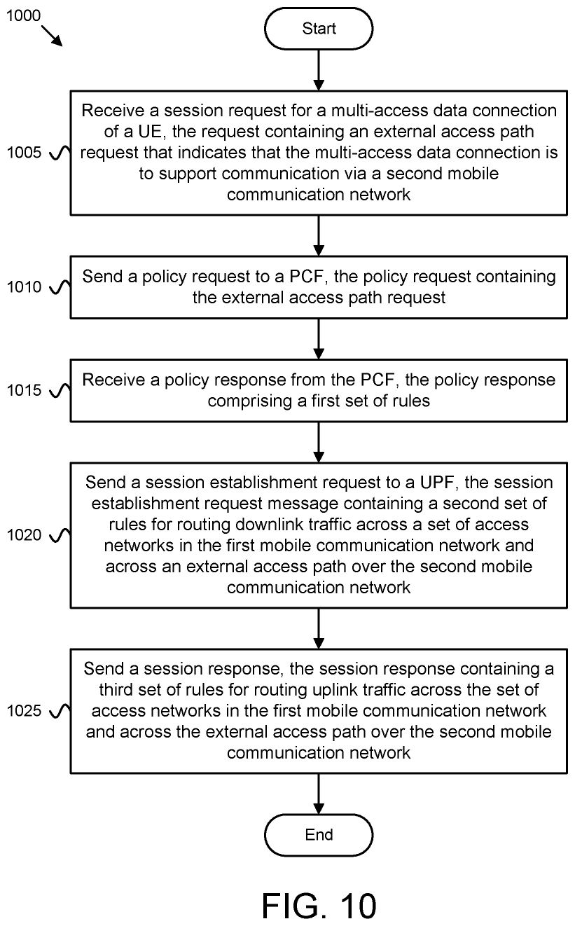

FIG. 10 depicts one embodiment of a method 1000 for establishing a multi-access data connection with an external access path, according to embodiments of the disclosure. In various embodiments, the method 1000 is performed by a session management function, such as the SMF 155, the SMF-2 313, and/or the network apparatus 600, as described above. In some embodiments, the method 1000 is performed by a processor, such as a microcontroller, a microprocessor, a CPU, a GPU, an auxiliary processing unit, a FPGA, or the like.

The method 1000 begins and receives 1005 a session request for a multi-access data connection (e.g., MA PDU session) of a UE, the request containing an external access path request that indicates that the multi-access data connection is to support communication via a second mobile communication network. The method 1000 includes sending 1010 a policy request to a PCF, the policy request containing the external access path request. The method 1000 includes receiving 1015 a policy response from the PCF, the policy response comprising a first set of rules. The method 1000 includes sending 1020 a session establishment request to a UPF, the session establishment request message containing a second set of rules for routing downlink traffic across a set of access networks in the first mobile communication network and across an external access path over the second mobile communication network. The method 1000 includes sending 1025 a session response, the session response containing a third set of rules for routing uplink traffic across the set of access networks in the first mobile communication network and across the external access path over the second mobile communication network. The method 1000 ends.

Disclosed herein is a first apparatus for establishing a multi-access data connection with an external access path, according to embodiments of the disclosure. The first apparatus may be implemented by a UE, such as the remote unit 105, the UE 205, and/or the user equipment apparatus 500. The first apparatus includes a processor and a transceiver (i.e., supporting a radio interface) that communicates with a first mobile communication network and a second mobile communication network via a plurality of access networks. The processor sends a first request message to the first mobile communication network (e.g., to PLMN-2 220) to establish a multi-access data connection. Here, the first request message includes an external access path request that indicates that the multi-access data connection is to support communication via the second mobile communication network (e.g., via PLMN-1 215).

Via the transceiver, the processor receives a response message from the first mobile communication network that accepts the request to establish a multi-access data connection. Here, the response message includes a set of rules (e.g., ATSSS rules) that indicate how the apparatus is to route data traffic across a set of access networks in the first mobile communication network and across an external access path over the second mobile communication network. Additionally, the processor communicates with a UPF in the first mobile communication network via the set of access networks and the external access path.

In some embodiments, communicating with the UPF in the first mobile communication network via the set of access networks and the external access path includes establishing a MPTCP connection with the UPF, where the MPTCP connection supports a set of TCP sub-flows, each TCP sub-flow carrying TCP traffic over a different access network in the first mobile communication network. In such embodiments, the processor receives a first address advertised by the UPF and sends a request to add a new TCP sub-flow to the MPTCP connection, where the new TCP sub-flow is to carry TCP traffic over the access network in the second mobile communication network. Here, the first address is advertised in response to the multi-access data connection supporting communication via the second mobile communication network and the request to add a new TCP sub-flow is sent to the first address via an access network in the second mobile communication network.

In some embodiments, the first request message includes an identity of the second mobile communication network and an IP address assigned by the second mobile communication network (e.g., “IP@x”). In some embodiments, the processor registers with the first mobile communication network using a set of credentials (e.g., using a first USIM) and registers with the second mobile communication network using a second set of credentials (e.g., using a second USIM).

In certain embodiments, the processor establishes a single-access data connection with the second mobile communication network prior to establishing the multi-access data connection with the first mobile communication network. In such embodiments, the first request message is to establish a MA PDU session. In other embodiments, the processor establishes a single-access data connection with the second mobile communication network after establishing the multi-access data connection with the second mobile communication network. In such embodiments, the first request message is to modify the multi-access PDU session.

Disclosed herein is a first method for establishing a multi-access data connection with an external access path. The first method may be performed by a UE, such as the remote unit 105, the UE 205, and/or the user equipment apparatus 500. The first method includes communicating with a first mobile communication network and a second mobile communication network via a plurality of access networks and sending a request message to the first mobile communication network (e.g., PLMN-2 220) to establish a multi-access data connection, where the request message includes an external access path request that indicates that the multi-access data connection is to support communication via the second mobile communication network (e.g., PLMN-1 215). The first method includes receiving a response message from the first mobile communication network that accepts the request to establish a multi-access data connection and communicating with a UPF in the first mobile communication network via the set of access networks and the external access path. Here, the response message includes a set of rules (e.g., ATSSS rules) indicating how the apparatus is to route data traffic across a set of access networks in the first mobile communication network and across an external access path over the second mobile communication network (e.g., via PLMN-1 215).

In some embodiments, communicating with the UPF in the first mobile communication network via the set of access networks and the external access path includes establishing a MPTCP connection with the UPF, where the MPTCP connection supports a set of transmission control protocol (“TCP”) sub-flows, each TCP sub-flow carrying TCP traffic over a different access network in the first mobile communication network. In such embodiments, the first method includes receiving a first address advertised by the UPF and sending a request to add a new TCP sub-flow to the MPTCP connection. In such embodiments, the first address is advertised in response to the multi-access data connection supporting communication via the second mobile communication network and the request is sent to the first address via an access network in the second mobile communication network, where the new TCP sub-flow is to carry TCP traffic over the access network in the second mobile communication network.

In some embodiments, the request message includes an identity of the second mobile communication network and an IP address (e.g., “IP@x”) assigned by the second mobile communication network. In some embodiments, the first method includes registering with the first mobile communication network using a set of credentials (e.g., using a first USIM) and registering with the second mobile communication network using a second set of credentials (e.g., using a second USIM).

In certain embodiments, the first method includes establishing a single-access data connection with the second mobile communication network prior to establishing a multi-access data connection with the first mobile communication network. In such embodiments, the request message is to establish a MA PDU session. In other embodiments, the first method includes establishing a single-access data connection with the second mobile communication network after establishing the multi-access data connection with the second mobile communication network. In such embodiments, the request message is to modify a MA PDU session.

Disclosed herein is a second apparatus for establishing a multi-access data connection with an external access path, according to embodiments of the disclosure. The second apparatus may be implemented by a policy control function, such as the PCF 157, the PCF-2 315, and/or the network apparatus 600. The second apparatus includes a processor and a transceiver (i.e., supporting a network interface) receives a policy request for a multi-access data connection (e.g., a MA PDU session) of a UE, where the policy request contains an external access path request that indicates that the multi-access data connection is to support communication via a second mobile communication network (e.g., PLMN-1 215). The processor generates a set of rules (e.g., PCC rules) and sends a response message to a session management function. Here, the set of rules indicate how the data traffic of the multi-access data connection is to be routed across a set of access networks in the first mobile communication network and across an external access path over the second mobile communication network and the response message contains the set of rules.

In some embodiments, the external access path request includes an identity of the second mobile communication network, where the processor authorizes the external access path request for the multi-access data connection. In certain embodiments, authorizing the external access path request includes determining that external access paths over the second mobile communication network (e.g., the PLMN-1 215) are allowed by an operator of the first mobile communication network (e.g., the PLMN-2 220). In one embodiment, the authorization is based on local policy. In another embodiment, the authorization is based on configuration information.

In some embodiments, the policy request contains an indication of whether the UE supports simultaneous transmission via the first and second mobile communication networks. In such embodiments, the set of rules is generated based on the indication. In some embodiments, the processor further creates an external access path information (“EAPI”) element for validating an external access path over the second mobile communication network. In such embodiments, the response message further includes the EAPI element.

Disclosed herein is a second method for establishing a multi-access data connection with an external access path, according to embodiments of the disclosure. The second method may be performed by a policy control function, such as the PCF 157, the PCF-2 315, and/or the network apparatus 600. The second method includes receiving a policy request for a multi-access data connection (e.g., MA PDU session) of a UE, the policy request containing an external access path request that indicates that the multi-access data connection is to support communication via a second mobile communication network. The second method includes generating a set of rules (e.g., PCC rules) and sending a response message to a session management function. Here, the set of rules indicates how data traffic of the multi-access data connection it to be routed across a set of access networks in the first mobile communication network and across an external access path over the second mobile communication network and the response message contains the set of rules.

In some embodiments, the external access path request comprises an identity of the second mobile communication network. In such embodiments, the second method includes authorizing the external access path request for the multi-access data connection. In certain embodiments, authorizing the external access path request includes determining that external access paths over the second mobile communication network (e.g., the PLMN-1 215) are allowed by an operator of the first mobile communication network (e.g., the PLMN-2 220). In one embodiment, the authorization is based on local policy. In another embodiment, the authorization is based on configuration information.

In some embodiments, the policy request contains an indication of whether the UE supports simultaneous transmission via the first and second mobile communication networks. In such embodiments, the set of rules is generated based on the indication. In some embodiments, the second method further includes creating an EAPI element for validating an external access path over the second mobile communication network. In such embodiments, the response message further includes the EAPI element.

Disclosed herein is a third apparatus for establishing a multi-access data connection with an external access path, according to embodiments of the disclosure. The third apparatus may be implemented by a user plane function, such as the UPF 151, the UPF-2 317, and/or the network apparatus 600. The third apparatus a processor and a transceiver (i.e., supporting a network interface) that receives a session establishment request for a multi-access data connection (e.g., a MA PDU session) of a UE, where the session establishment request contains a set of rules (e.g., N4 rules) for routing downlink traffic of the multi-access data connection across a set of access networks in the first mobile communication network and across an external access path over a second mobile communication network.

The processor assigns a first network address to the multi-access data connection for enabling UE communication via the set of access networks in the first mobile communication network and assigns a second network address to the multi-access data connection for communicating with the UE via the external access path over the second mobile communication network. Using the transceiver, the processor communicates with the UE via the set of access networks and the external access path.

In some embodiments, communicating with the UE via the first a set of access networks and the external access path includes establishing a MPTCP connection with the UE and advertising availability of the second address to the UE. Here, the MPTCP connection supports a first set of TCP sub-flows, each TCP sub-flow carrying TCP traffic over a different access network in the first mobile communication network. In such embodiments, the second address is advertised in response to the multi-access data connection supporting communication via the second mobile communication network. In certain embodiments, the second address is the same as the first address.

In certain embodiments, the session establishment request further contains an EAPI element for validating the external access path over the second mobile communication network. In such embodiments, the processor uses the EAPI element to validate that a request to add a new TCP sub-flow to the MPTCP is sent via the second mobile communication network and accepts the new TCP sub-flow in response to validating the request, where the new TCP sub-flow is to carry TCP traffic over an access network in the second mobile communication network.

Disclosed herein is a third method for establishing a multi-access data connection with an external access path, according to embodiments of the disclosure. The third method may be performed by a user plane function, such as the UPF 151, the UPF-2 317, and/or the network apparatus 600. The third method includes receiving a session establishment request for a multi-access data connection (e.g., MA PDU session) of a UE, the session establishment request containing a set of rules (e.g., N4 rules) for routing downlink traffic of the multi-access data connection across a set of access networks in the first mobile communication network and across an external access path over a second mobile communication network.

The third method includes assigning a first network address to the multi-access data connection for enabling UE communication via the set of access networks in the first mobile communication network and assigning a second network address to the multi-access data connection for communicating with the UE via the external access path over the second mobile communication network. The third method includes communicating with the UE via the set of access networks and the external access path.

In some embodiments, communicating with the UE via the set of access networks and the external access path includes establishing a MPTCP connection with the UE and advertising availability of the second address to the UE. Here, the MPTCP connection supports a first set of TCP sub-flows, each TCP sub-flow carrying TCP traffic over a different access network in the first mobile communication network. In such embodiments, the second address is advertised in response to the multi-access data connection supporting communication via the second mobile communication network. In certain embodiments, the second address is the same as the first address.

In certain embodiments, the session establishment request further contains an EAPI element for validating the external access path over the second mobile communication network. In such embodiments, the third method includes using the EAPI element to validate that a request to add a new TCP sub-flow to the MPTCP is sent via the second mobile communication network and accepting the new TCP sub-flow in response to validating the request, where the new TCP sub-flow is to carry TCP traffic over an access network in the second mobile communication network.

Disclosed herein is a fourth apparatus for establishing a multi-access data connection with an external access path, according to embodiments of the disclosure. The fourth apparatus may be implemented by a session management function, such as the SMF 155, the SMF-2 313, and/or the network apparatus 600. The fourth apparatus a transceiver (i.e., supporting a network interface) that communicates with at least one network function in the first mobile communication network (e.g., the PLMN-2 220). The processor receives a session request (e.g., a Create SM Context request or an Update SM Context request) for a multi-access data connection (e.g., a MA PDU session) of a UE and sends a policy request to a PCF. Here, both the session request and the policy request contain an external access path request that indicates that the multi-access data connection is to support communication via a second mobile communication network.

The processor further receives a policy response from the PCF, the policy response comprising a first set of rules (e.g., PCC rules) and sends a session establishment request to a UPF, where the session establishment request message contains a second set of rules (e.g., N4 rules) for routing downlink traffic across a set of access networks in the first mobile communication network and across an external access path over the second mobile communication network. The processor additionally sends a session response message (e.g., a Create SM Context response or an Update SM Context response) that contains a third set of rules (e.g., ATSSS rules) for routing uplink traffic across the set of access networks in the first mobile communication network and across the external access path over the second mobile communication network.

In some embodiments, the policy response includes an EAPI element for validating an external access path over the second mobile communication network. In such embodiments, the session establishment request contains the EAPI.

Disclosed herein is a fourth method for establishing a multi-access data connection with an external access path, according to embodiments of the disclosure. The fourth method may be performed by a session management function, such as the SMF 155, the SMF-2 313, and/or the network apparatus 600. The fourth method includes receiving a session request (e.g., a Create SM Context request or an Update SM Context request) for a multi-access data connection (e.g., a MA PDU session) of a UE and sending a policy request to a PCF. Here, each of the session request and the policy request contains an external access path request that indicates that the multi-access data connection is to support communication via a second mobile communication network.

The fourth method includes receiving a policy response from the PCF, the policy response comprising a first set of rules (e.g., PCC rules) and sending a session establishment request message to a UPF, where the session establishment request message contains a second set of rules (e.g., N4 rules) for routing downlink traffic across a set of access networks in the first mobile communication network and across an external access path over the second mobile communication network. The fourth method also includes sending a session response message (e.g., a Create SM Context response or an Update SM Context response) that contains a third set of rules (e.g., ATSSS rules) for routing uplink traffic across the set of access networks in the first mobile communication network and across the external access path over the second mobile communication network.

In some embodiments, the policy response comprises an EAPI element for validating an external access path over the second mobile communication network. In such embodiments, the session establishment request contains the EAPI.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A User Equipment (“UE”) apparatus comprising:
a transceiver that communicates with a first mobile communication network and a second mobile communication network via a plurality of access networks; and
a processor that:
sends a request message to the first mobile communication network to establish a multi-access data connection, wherein the request message comprises an external access path request that indicates that the multi-access data connection is to support communication via the second mobile communication network;
receives a response message from the first mobile communication network that accepts the request to establish a multi-access data connection, wherein the response message comprises a set of rules indicating how the apparatus is to route data traffic across a set of access networks in the first mobile communication network and across an external access path over the second mobile communication network; and
communicates with a user plane function (“UPF”) in the first mobile communication network via the set of access networks and the external access path.

2. The apparatus of claim 1, wherein communicating with the UPF in the first mobile communication network via the set of access networks and the external access path comprises:
establishing a multi-path transmission control protocol (“MPTCP”) connection with the UPF, wherein the MPTCP connection supports a set of transmission control protocol (“TCP”) sub-flows, each TCP sub-flow carrying TCP traffic over a different access network in the first mobile communication network;
receiving a first address advertised by the UPF, wherein the first address is advertised in response to the multi-access data connection supporting communication via the second mobile communication network; and
sending a request to add a new TCP sub-flow to the MPTCP connection, wherein the request is sent to the first address via an access network in the second mobile communication network, wherein the new TCP sub-flow is to carry TCP traffic over the access network in the second mobile communication network.

3. The apparatus of claim 1 or 2, wherein the processor registers with the first mobile communication network using a set of credentials and registers with the second mobile communication network using a second set of credentials.

4. The apparatus of claim 3, wherein the processor establishes a single-access data connection with the second mobile communication network prior to establishing the multi-access data connection with the first mobile communication network, wherein the request message is to establish a multi-access Protocol Data Unit (“PDU”) session.

5. The apparatus of claim 3, wherein the processor establishes a single-access data connection with the second mobile communication network after establishing the multi-access data connection with the second mobile communication network, wherein the request message is to modify the multi-access PDU session.

6. The apparatus of any preceding claim, wherein the request comprises an identity of the second mobile communication network and an IP address assigned by the second mobile communication network.

7. An apparatus in a first mobile communication network, the apparatus comprising:
a transceiver that receives a policy request for a multi-access data connection of a user equipment (“UE”), the policy request containing an external access path request that indicates that the multi-access data connection is to support communication via a second mobile communication network; and
a processor that:
generates a set of rules indicating how the data traffic of the multi-access data connection is to be routed across a set of access networks in the first mobile communication network and across an external access path over the second mobile communication network; and
sends a response message to a session management function, the response message comprising the set of rules.

8. The apparatus of claim 7, wherein the external access path request comprises an identity of the second mobile communication network, wherein the processor authorizes the external access path request for the multi-access data connection.

9. The apparatus of claim 8, wherein authorizing the external access path request comprises determining that external access paths over the second mobile communication network are allowed by an operator of the first mobile communication network.

10. The apparatus of claim 7, 8 or 9, wherein the policy request comprises an indication of whether the UE supports simultaneous transmission via the first and second mobile communication networks, wherein the set of rules is generated based on the indication.

11. The apparatus of any of claims 7 to 10, wherein the processor further creates an external access path information (“EAPI”) element for validating an external access path over the second mobile communication network, wherein the response message further comprises the EAPI element.

12. An apparatus in a first mobile communication network, the apparatus comprising:
a transceiver that receives a session establishment request for a multi-access data connection of a user equipment (“UE”), the session establishment request containing a set of rules for routing downlink traffic of the multi-access data connection across a set of access networks in the first mobile communication network and across an external access path over a second mobile communication network; and
a processor that:
assigns a first network address to the multi-access data connection for enabling UE communication via the set of access networks in the first mobile communication network;
assigns a second network address to the multi-access data connection for communicating with the UE via the external access path over the second mobile communication network; and
communicates with the UE via the set of access networks and the external access path.

13. The apparatus of claim 12, wherein communicating with the UPF in the first mobile communication network via the set of access networks and the external access path comprises:
establishing a multipath transmission control protocol (“MPTCP”) connection with the UE, wherein the MPTCP connection supports a first set of transmission control protocol (“TCP”) sub-flows, each TCP sub-flow carrying TCP traffic over a different access network in the first mobile communication network; and
advertising availability of the second address to the UE, wherein the second address is advertised in response to the multi-access data connection supporting communication via the second mobile communication network.

14. The apparatus of claim 13, wherein the session establishment request further contains an external access path information (“EAPI”) element for validating the external access path over the second mobile communication network, wherein the processor uses the EAPI element to validate that a request to add a new TCP sub-flow to the MPTCP is sent via the second mobile communication network, wherein the processor accepts the new TCP sub-flow in response to validating the request, wherein the new TCP sub-flow is to carry TCP traffic over an access network in the second mobile communication network.

15. The apparatus of any of claims 12 to 14, wherein the second address is the same as the first address.
